(19) United States
(12) Patent Application Publication
(10) Pub. No.: US 2025/0307256 A1
(43) Pub. Date: Oct. 2, 2025

(54) TEXT PROCESSING METHOD, TEXT PROCESSING APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Jin MA, Shenzhen (CN); Sijiao CHEN, Shenzhen (CN); Peilu WANG, Shenzhen (CN); Xinyu ZUO, Shenzhen (CN); Junlang ZHAN, Shenzhen (CN)

(21) Appl. No.: 19/234,201

(22) Filed: Jun. 10, 2025

Related U.S. Application Data
(63) Continuation of application No. PCT/CN2023/132040, filed on Nov. 16, 2023.

(30) Foreign Application Priority Data
May 11, 2023 (CN) 202310525850.2

(51) Int. Cl. G06F 16/2457; G06F 16/953

(52) U.S. Cl. CPC G06F 16/24578; G06F 16/953

(57) ABSTRACT

A text processing method includes obtaining a query text, invoking a search engine interface based on the query text to obtain a plurality of text search results corresponding to the query text, obtaining, from the plurality of text search results, a plurality of answer text segments matching the query text, determining a relevance between the query text and each of the plurality of answer text segments, determining one of the plurality of answer text segments that corresponds to a maximum relevance as a reference text of the query text, and invoking a language model based on the query text and the reference text to obtain a reply text of the query text.

### CROSS-REFERENCE TO RELATED APPLICATIONS

This application is a continuation of International Application No. PCT/CN2023/132040, filed on Nov. 16, 2023, which is based upon and claims priority to Chinese Patent Application No. 202310525850.2, filed on May 11, 2023, the entire contents of both of which are incorporated herein by reference.

### FIELD OF THE TECHNOLOGY

This application relates to artificial intelligence technologies, and in particular, to a text processing method, a text processing apparatus, an electronic device, and a computer-readable storage medium.

### BACKGROUND OF THE DISCLOSURE

Nature Language processing (NLP) is an important direction in the computer science field and the artificial intelligence field. It studies various theories and methods that can implement effective communication between people and computers by using natural languages. The nature language processing involves natural languages, that is, languages that people use on a daily basis, and therefore, is close to the study of linguistics. The nature language processing also involves important technologies for model training in the fields of computer science, mathematics, and artificial intelligence.

In the related art, a large language model (LLM) is usually configured to learn and understand natural languages, and automatically generate a corresponding text in a downstream task based on a given context. Generally, the large language model is usually based on a transformer architecture, and has a huge quantity of model parameters, making both deployment and training difficult. However, the large language model does not have an information obtaining capability and a self-updating capability. In the case of low model update frequency, text generation can only occur within a fixed existing natural language scope, resulting in content with limitations and low controllability. Since the large language model cannot incorporate and learn new natural languages in time, information disconnection may be caused between the generated text and the given text, leading to large differences in properties at different times, resulting in poor timeliness of the generated text content.

### SUMMARY

In accordance with the disclosure, there is provided a text processing method including obtaining a query text, invoking a search engine interface based on the query text to obtain a plurality of text search results corresponding to the query text, obtaining, from the plurality of text search results, a plurality of answer text segments matching the query text, determining a relevance between the query text and each of the plurality of answer text segments, determining one of the plurality of answer text segments that corresponds to a maximum relevance as a reference text of the query text, and invoking a language model based on the query text and the reference text to obtain a reply text of the query text.

Also in accordance with the disclosure, there is provided an electronic device including a memory storing computer-executable instructions or a computer program, and a processor configured to execute the computer-executable instructions or the computer program to obtain a query text, invoke a search engine interface based on the query text to obtain a plurality of text search results corresponding to the query text, obtain, from the plurality of text search results, a plurality of answer text segments matching the query text, determine a relevance between the query text and each of the plurality of answer text segments, determine one of the plurality of answer text segments that corresponds to a maximum relevance as a reference text of the query text, and invoke a language model based on the query text and the reference text to obtain a reply text of the query text.

Also in accordance with the disclosure, there is provided a non-transitory computer-readable storage medium storing computer-executable instructions or a computer program that, when executed by a processor, causes an electronic device having the processor to obtain a query text, invoke a search engine interface based on the query text to obtain a plurality of text search results corresponding to the query text, obtain, from the plurality of text search results, a plurality of answer text segments matching the query text, determine a relevance between the query text and each of the plurality of answer text segments, determine one of the plurality of answer text segments that corresponds to a maximum relevance as a reference text of the query text, and invoke a language model based on the query text and the reference text to obtain a reply text of the query text.

### BRIEF DESCRIPTION OF THE DRAWINGS

FIG. 1 is a schematic architectural diagram of a text processing system according to an embodiment of this application.

FIG. 2 is a schematic structural diagram of an electronic device according to an embodiment of this application.

FIG. 3A to FIG. 3L are schematic flowcharts of a text processing method according to an embodiment of this application.

FIG. 4 is a processing flowchart of a text processing method according to an embodiment of this application.

FIG. 5 is a processing process diagram of extracting an answer text segment according to an embodiment of this application.

FIG. 6 is a process diagram of determining a relevance score between a query text and an answer text segment according to an embodiment of this application.

FIG. 7 is a processing flowchart of performing citation alignment on a generated text according to an embodiment of this application.

FIG. 8 is a prediction process diagram of a semantic similarity matching model according to an embodiment of this application.

### DESCRIPTION OF EMBODIMENTS

To make objectives, technical solutions, and advantages of this application clearer, the following further describes this application in detail with accompanying drawings. The described embodiments do not be construed as limitation on this application. All other embodiments obtained by a person of ordinary skill in the art based on the embodiments of this application without creative efforts shall fall within the protection scope of this application.

“Some embodiments” involved in the following description describes a subset of all possible embodiments. However, “some embodiments” may be same or different subsets of all the possible embodiments, and may be combined with each other when there is no conflict.

In the following description, the terms “first,” “second,” and “third” are merely intended to distinguish between similar objects and do not indicate a specific sequence of the objects. A specific order or sequence of the “first,” “second,” and “third” may be interchanged if permitted, so that the embodiments of this application described herein may be implemented in a sequence other than the sequence illustrated or described herein.

In the embodiments of this application, related data such as user information (for example, a query text inputted by a user through a terminal device) is involved. When the embodiments of this application is applied to a specific product or technology, user permission or consent needs to be obtained, and the related data needs to be collected, used, and processed by complying with the laws, regulations, and standards of related countries and regions.

Unless otherwise defined, meanings of all technical and scientific terms used in this specification are the same as those usually understood by a person skilled in the art. Terms used in the embodiments of this application are merely intended to describe objectives of the embodiments of this application, but are not intended to limit this application.

Before the embodiments of this application are further described in detail, terms involved in the embodiments of this application are described, and the following explanations are applicable to the terms involved in the embodiments of this application.

(1) A large language model (LLM), briefly referred to as a language model, can process and generate a machine learning model for natural languages, for example, generate a generative pre-training model (GPT) model based on a bidirectional encoder representation from transformers (BERT) model. Prediction tasks of the language model may include text classification, cloze test, question answering, and the like.

(2) Timeliness refers to a large property difference of the same object at different times, and this difference is referred to as timeliness. When the large language model generates text content, poor timeliness refers to that the large language model cannot incorporate new language knowledge in real time to update the scope of mastered language knowledge, resulting in a limited content range of the generated text.

(3) The bidirectional encoder representation from transformers (BERT) model is a pre-training text processing model, which may encode a text, and may be applied to various application scenarios such as text generation, text similarity determining, and text identification.

The embodiments of this application provide a text processing method and apparatus, an electronic device, a computer-readable storage medium, and a computer program product, to improve the timeliness of a text generated by a language model.

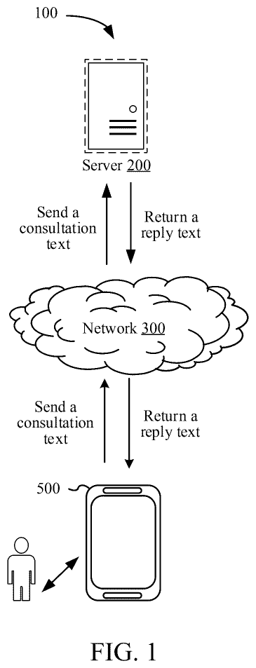

Referring to FIG. 1, FIG. 1 is a schematic architectural diagram of a text processing system 100 according to an embodiment of this application. The text processing system 100 includes a terminal 500, a network 300, and a server 200. The terminal 500 is connected to the server 200 through the network 300. The network 300 may be a wide area network, a local area network, or a combination thereof.

In a first application scenario, various applications (APPs) for a text editing or text processing application scenario are run in the terminal 500. After a user inputs a to-be-answered consultation text that needs to be answered in a text editing interface of an APP, the consultation text is received and sent to the server 200 through the network 300. After receiving the consultation text sent by the terminal, the server 200 uses the consultation text as a query text, and invokes a search engine interface, to obtain a plurality of text search results corresponding to the query text. Then, a plurality of answer text segments matching the query text are obtained from the plurality of text search results, and selection is performed on the answer text segments based on relevances, to obtain a reference text. Finally, the language model is invoked based on the query text, to obtain a reply text corresponding to the query text from the reference text, and the obtained reply text is returned to the terminal 500 through the network 300, and displayed on the text editing interface of the corresponding APP in the terminal 500.

In a second application scenario, after the user inputs, in the text editing interface of the application of the terminal, the to-be-answered consultation text that needs to be answered, the terminal may directly process the consultation text. Specifically, the consultation text is used as the query text, and the search engine interface is invoked to obtain the plurality of text search results corresponding to the query text. Then, the plurality of answer text segments matching the query text are obtained from the plurality of text search results, and selection is performed on the answer text segments based on the relevances, to obtain the reference text. Finally, the language model is invoked based on the query text, to obtain the reply text corresponding to the query text from the reference text, and then the reply text is directly displayed on the text editing interface.

In some embodiments, the server 200 shown in FIG. 1 may be an independent physical server, or a server cluster or a distributed system composed of a plurality of physical servers, or may alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The terminal 500 shown in FIG. 1 may be a smartphone, a tablet, a laptop, a desktop computer, a smart speaker, a smart watch, a smart television, or a vehicle-mounted terminal, but this is not limited. The terminal and the server may be connected directly or indirectly in a wired or wireless communication manner. This is not limited in this embodiment of this application.

The embodiments of this application may be implemented by using an artificial intelligence (AI) technology. The artificial intelligence technology is a theory, a method, a technology, and an application system that use a digital computer or a machine controlled by the digital computer to simulate, extend, and expand human intelligence, perceive an environment, obtain knowledge, and use the knowledge to obtain an optimal result. In other words, the artificial intelligence is a comprehensive technology in computer science. An objective of the artificial intelligence is to understand an essence of intelligence, and produce a new intelligent machine that can react in a manner similar to the human intelligence. The artificial intelligence is to study design principles and implementation methods of various intelligent machines, to enable the machines to have functions of perception, reasoning, and decision-making.

The server according to this embodiment of this application is used as an example, for example, the server is a server cluster that may be deployed in a cloud, to open an AI as a Service (AIaaS) to a user or a developer, and an AIaaS platform splits several types of common AI services, and provides an independent or packaged service in a cloud. This service mode is similar to opening an AI theme marketplace, so that all users or developers can access, through an application programming interface, one or more types of artificial intelligence services provided by the AIaaS platform.

For example, a text processing program provided in this embodiment of this application is encapsulated in a cloud server. The user invokes a text processing service in the cloud service through a terminal device (a text editing application is run on the terminal device), so that the server deployed on the cloud invokes the encapsulated text processing program, receives the to-be-answered consultation text inputted by the user, uses the consultation text as the query text, and invokes the search engine interface to obtain the plurality of text search results corresponding to the query text. Then, the plurality of answer text segments matching the query text are obtained from the plurality of text search results, and selection is performed on the answer text segments based on the relevances, to obtain the reference text. Finally, the language model is invoked based on the query text, to obtain the reply text corresponding to the query text from the reference text, so that the reply text is directly displayed on the terminal device.

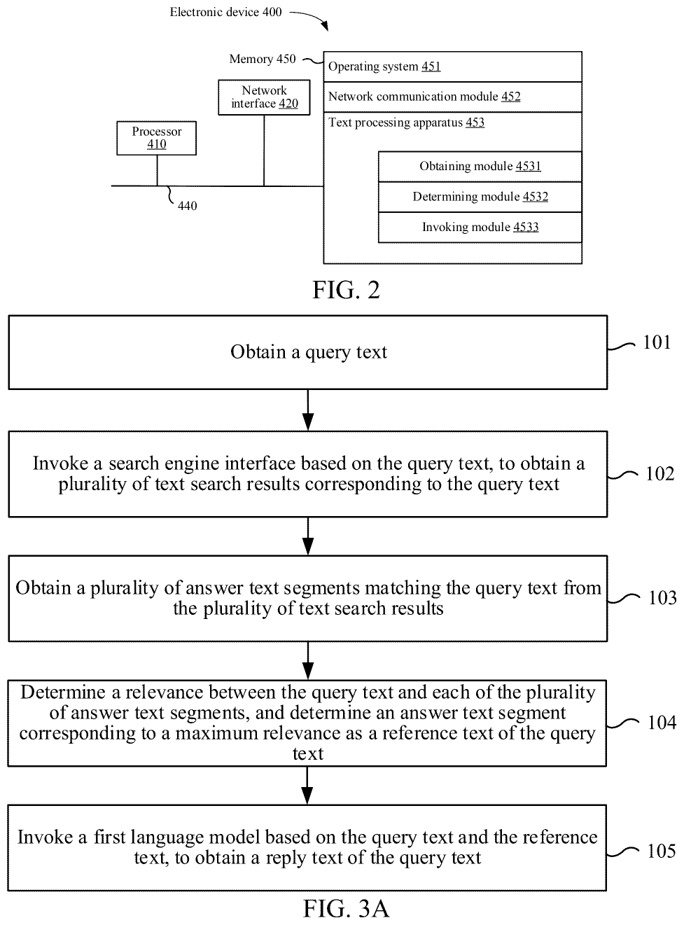

Referring to FIG. 2, FIG. 2 is a schematic structural diagram of an electronic device 400 according to an embodiment of this application. The electronic device 400 may be implemented as the server in the foregoing first application scenario, or may be implemented as the terminal in the foregoing second application scenario. The electronic device 400 shown in FIG. 2 includes at least one processor 410, a memory 450, and at least one network interface 420. All components in the electronic device 400 are coupled together through a bus system 440. The bus system 440 is configured to implement connection and communication between the components. In addition to a data bus, the bus system 440 further includes a power bus, a control bus, and a status signal bus. However, for ease of clear description, all types of buses are tokened as the bus system 440 in FIG. 2.

The processor 410 may be an integrated circuit chip having a signal processing ability, for example, a general processor, a digital signal processor (DSP), or another programmable logic device, a discrete gate or a transistor logic device, or a discrete hardware component, where the general processor may be a microprocessor, any conventional processor, or the like.

The memory 450 may be a removable memory, a non-removable memory, or a combination of a removable memory and a non-removable memory. Exemplary hardware devices include a solid state memory, a hard drive, an optical disk drive, and the like. In some embodiments, the memory 450 includes one or more storage devices physically remote from the processor 410.

The memory 450 may be a volatile memory or a non-volatile memory, or may include both a volatile memory and a non-volatile memory. The non-volatile memory may be a read only memory (ROM), or the volatile memory may be a random access memory (RAM). The memory 450 described in the embodiments of this application is intended to include, but is not limited to, memories of any suitable type.

In some embodiments, the memory 450 can store data to support various operations. An example of the data includes a program, a module, a data structure, or a subset or a superset of the data. The following is an example for description.

An operating system 451 includes a system program configured to handle various basic system services and perform a hardware related task, for example, a framework layer, a core library layer, or a driver layer, configured for implementing various basic services and processing a task based on hardware.

A network communication module 452 is configured to reach another electronic device through one or more (wired or wireless) network interfaces 420. Exemplary network interfaces 420 include Bluetooth, wireless fidelity (Wi-Fi), a universal serial bus (USB), and the like.

In some embodiments, an apparatus according to the embodiments of this application may be implemented by using software. FIG. 2 shows a text processing apparatus 453 stored in the memory 450. The text processing apparatus 453 may be software in a form of a program, a plug-in, and the like, including the following software modules: an obtaining module 4531, a determining module 4532, and an invoking module 4533. These modules are logical and may be arbitrarily combined or further split depending on implemented functions. Functions of the modules are described below.

In some embodiments, the terminal or the server may implement the text processing method according to the embodiments of this application by running various computer-executable instructions or computer programs. For example, the computer-executable instructions may be microprogram-level commands, machine instructions, or software instructions. The computer program may be a native program or a software module in the operating system, may be a native application (APP), that is, a program that can be run only when being installed in the operating system, or may be a mini program that can be embedded in any APP, that is, a program that can be run only when being downloaded to a browser environment. In conclusion, the computer-executable instructions may be instructions in any form, and the computer program may be an application, a module, or a plug-in in any form.

The text processing method according to the embodiments of this application is described with reference to exemplary applications and implementations of the electronic device according to the embodiments of this application.

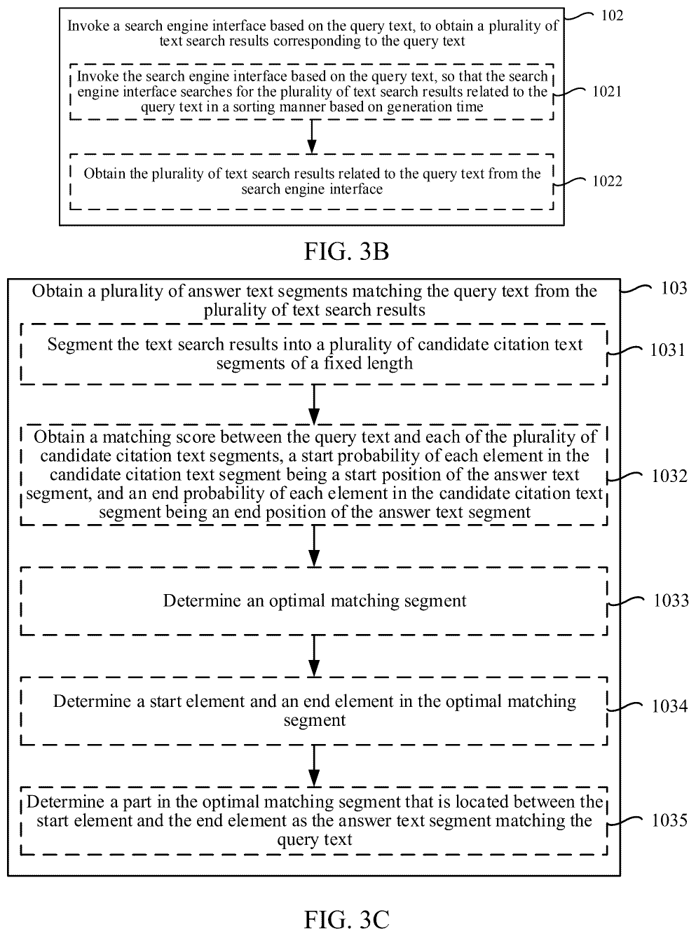

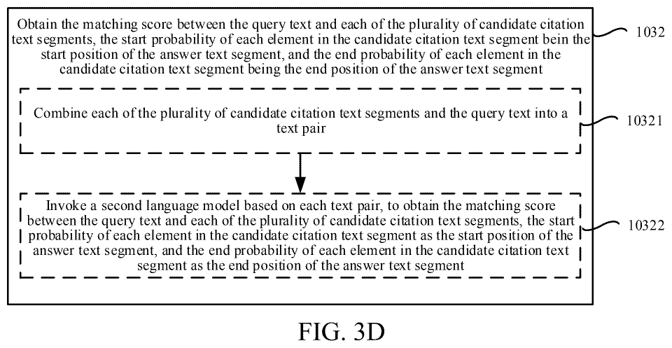

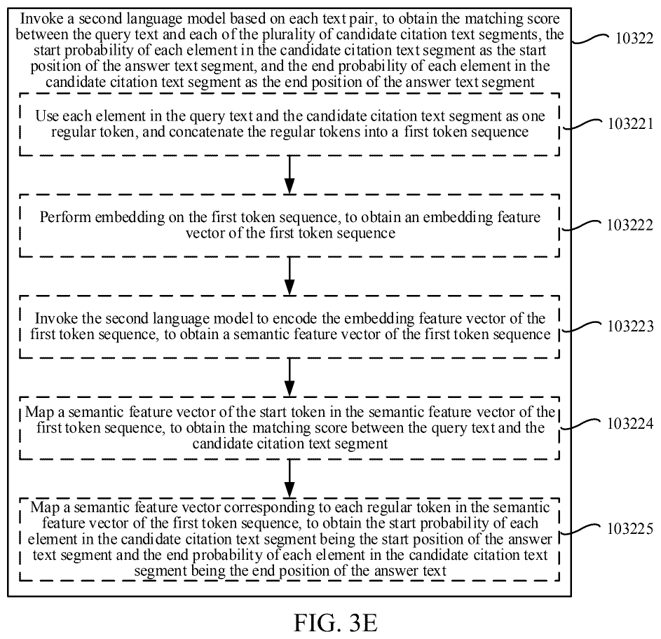

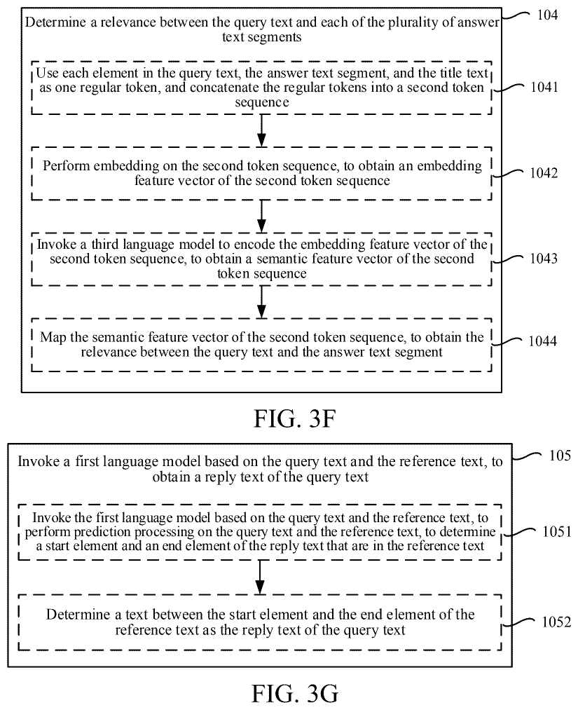

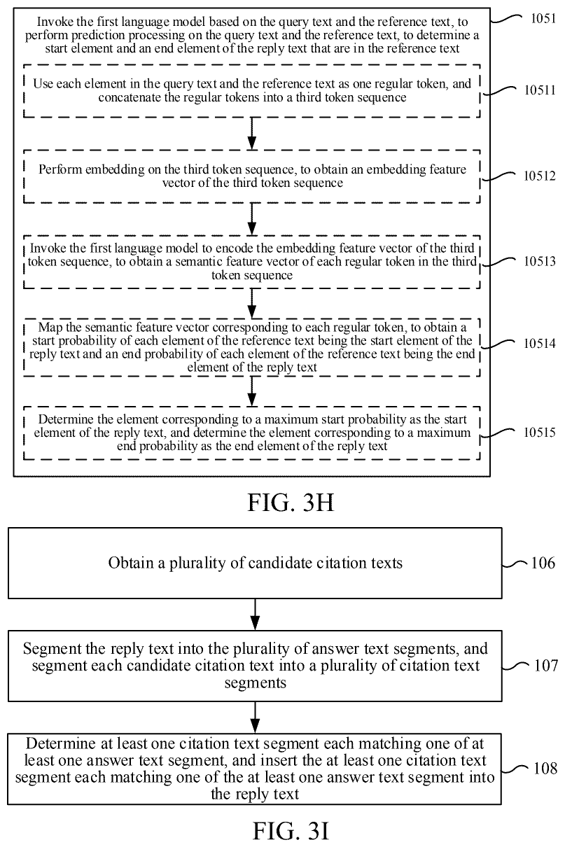

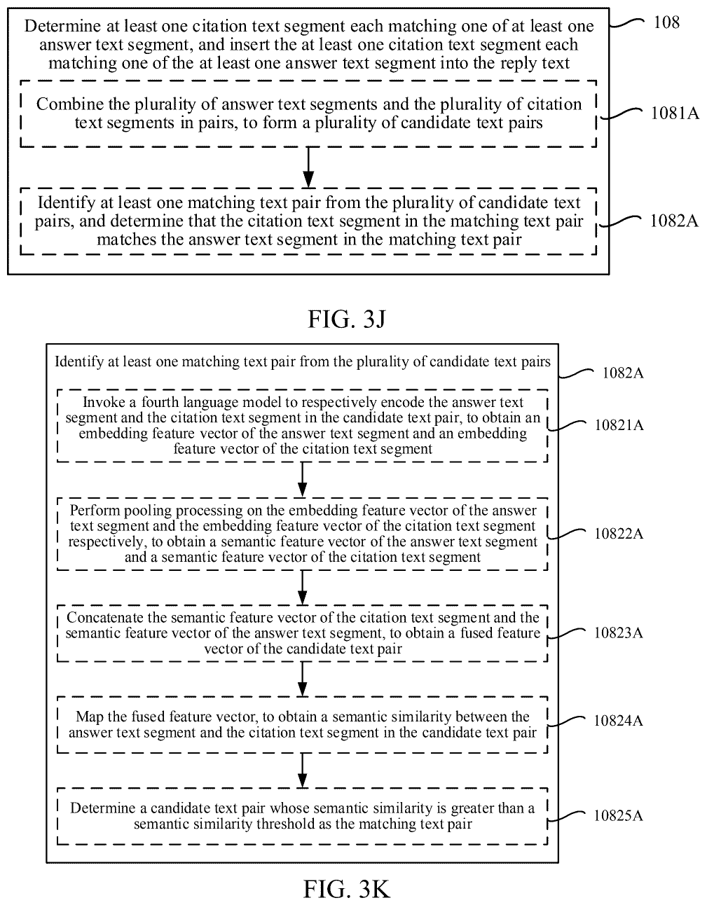

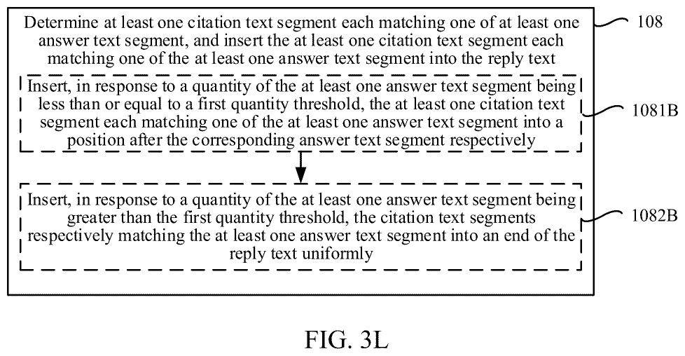

Referring to FIG. 3A, FIG. 3A is a schematic flowchart of a text processing method according to an embodiment of this application. An execution body may be the server in the foregoing first application scenario or the terminal device in the foregoing second application scenario. The execution body is not described in detail below, and operations shown in FIG. 3A are described below.

Operation 101: Obtain a query text.

In some embodiments, the query text is generally related to a corresponding application scenario, for example, may be a context and a prompt word given in the application scenario, may be consultation text that needs to be answered, may be a search keyword corresponding to a search system scenario, or may be a search item including a plurality of search keywords. The query text is mainly configured for obtaining latest search information, to extract answer text segments matching the query text, and provide a corresponding reference text for a first language model.

Operation 102: Invoke a search engine interface based on the query text, to obtain a plurality of text search results corresponding to the query text.

For example, the search engine interface is invoked based on the query text, to perform a search operation in a network or a specific database. A source of the search result may be a webpage, a social platform, or the like. In a search result list obtained through the search engine interface, search results are sorted in ascending order of a time difference between generation time and a current moment, and a search result that corresponds to latest generation time is displayed at the top.

In some embodiments, referring to FIG. 3B, operation 102 shown in FIG. 3A may be implemented through the following operation 1021 and operation 1022. Details are described below.

Operation 1021: Invoke the search engine interface based on the query text, so that the search engine interface searches for the plurality of text search results related to the query text in a sorting manner based on the generation time. That is, the plurality of text search results obtained by the search engine interface are sorted according to the generation times of the text search results.

After the query text is obtained, the related search engine interface is invoked to obtain the plurality of text search results based on the query text. The search engine interface may be an interface of a search server, a search interface invoked from a related terminal browser, or another engine or function interface having a search function. A search manner of the search engine interface is the manner of sorting based on the generation time, that is, search information with latest generation time is sorted and displayed on the head. The text search result may be generally in a pure-text form, or may be in a rich-media form. For the rich-media form, a text in the text search result may be extracted, and generally includes a body text and a corresponding text title.

Operation 1022: Obtain the plurality of text search results related to the query text from the search engine interface.

After the search engine interface is invoked to search the query text, the plurality of text search results are obtained, and then the plurality of text search results related to the query text are sequentially obtained from the search engine interface in a sorting manner based on generation time of the text search results, that is, the plurality of text search results related to the query text that have latest generation time are obtained.

In this embodiment of this application, the query text is used, and the latest search information related to the query text is obtained from the search engine interface according to a principle of prioritizing timeliness, to subsequently select the reference text, thereby ensuring the timeliness of reference text information.

Still refer to FIG. 3A. Operation 103: Obtain a plurality of answer text segments matching the query text from the plurality of text search results.

In the body text included in the text search result, only part of the text may be used as an answer to the query text, and the other part of the text is text information irrelevant to the query text. Therefore, these text segments that may be used as answers need to be extracted from the body text included in the text search result.

In some embodiments, referring to FIG. 3C, FIG. 3C is a schematic flowchart of a text processing method according to an embodiment of this application. Operation 103 shown in FIG. 3A may be implemented through operation 1031 to operation 1035 in FIG. 3C. Details are described below.

Operation 1031: Segment the text search results into a plurality of candidate citation text segments of a fixed length.

Only part of the body text included in the text search result may be used as the answer text segment matching the query text. Therefore, the body text in each text search result is segmented based on the fixed length, to obtain the plurality of candidate citation text segments. The fixed length of the candidate citation text segment may be set based on a text scale or a quantity of segments of an actual text search result, for example, may be 500. The fixed length is positively correlated to the text scale or the quantity of segments of the actual text search result.

Operation 1032: Obtain a matching score between the query text and each of the plurality of candidate citation text segments, a start probability of each element in the candidate citation text segment being a start position of the answer text segment, and an end probability of each element in the candidate citation text segment being an end position of the answer text segment. The start probability of an element being the start position of the answer text segment is also referred to refers to as a “start position probability” of the element, and the end probability of an element being the end position of the answer text segment is also referred to as an “end position probability” of the element.

After the body text is segmented, to determine the candidate citation text segments matching the query text, the query text may be combined with each of the candidate citation text segments, and combination results are inputted into a relevance model for processing, to predict the matching score between the query text and each of the plurality of candidate citation text segments. Considering that the answer text segment matching the query text are selected from the candidate citation text segments, whether each element in the candidate citation text segment may be used as a start element and an end element of the answer text segment is determined, to determine the start position and the end position of the answer text segment in the candidate citation text segment.

In some embodiments, referring to FIG. 3D, FIG. 3D is a schematic flowchart of a text processing method according to an embodiment of this application. Operation 1032 shown in FIG. 3C may be implemented through operation 10321 and operation 10322 in FIG. 3D. Details are described below.

Operation 10321: Combine each of the plurality of candidate citation text segments and the query text into a text pair.

In some embodiments, to predict the matching score between the query text and each of the plurality of candidate citation text segments, a similarity between the query text and the candidate citation text segment needs to be determined. In this embodiment of this application, each of the plurality of candidate citation text segments and the query text are combined into the text pair, to predict the similarity between the query text and the candidate citation text segment in the text pair using a second language model subsequently.

Operation 10322: Invoke the second language model based on each text pair, to obtain the matching score between the query text and each of the plurality of candidate citation text segments, the start probability of each element in the candidate citation text segment being the start position of the answer text segment, and the end probability of each element in the candidate citation text segment being the end position of the answer text segment.

Based on the foregoing embodiment, after the query text and each of the candidate citation text segments are combined into the text pair, the second language model is invoked to process the text pair, to obtain the matching score between the query text and each of the plurality of candidate citation text segments. The matching score represents a similarity between semantics of a candidate citation text and semantics of the query text. A higher matching score indicates similar semantics.

The obtaining whether each element in the candidate citation text segment in the text pair is suitable for being used as the start element and the end element of the answer text segment may be implemented in the following manner: determining the start probability of each element in the candidate citation text segment being the start position of the answer text segment and the end probability of each element in the candidate citation text segment being the end position of the answer text segment; selecting the element having a highest start probability as the start position; and selecting the element having a highest end probability as the end position.

In some embodiments, referring to FIG. 3E, FIG. 3E is a schematic flowchart of a text processing method according to an embodiment of this application. Operation 10322 shown in FIG. 3D may be implemented through operation 103221 to operation 103225 in FIG. 3E. Details are described below.

Operation 103221: Use each element in the query text and the candidate citation text segment as one regular token, and concatenate the regular tokens into a first token sequence.

Before the second language model is invoked to process the text pair, an embedding feature vector of the text pair is obtained. Therefore, each element in the query text and the candidate citation text segment is used as one regular token. The regular token is relative to a start token and a separator token, and is configured to represent a text token of a text element. Then, all regular tokens are concatenated into the first token sequence. The element may be a character, a word, or a short sentence in the text. This is because some texts may fail to express specific semantic information if the texts are forcibly distinguished based on characters or words. Finally, the start token (CLS) is inserted into a head of the first token sequence.

Operation 103222: Perform embedding on the first token sequence, to obtain an embedding feature vector of the first token sequence.

Based on the foregoing embodiment, after the first token sequence into which the start token is inserted is obtained, embedding is performed on the first token sequence, and the first token sequence is mapped into the embedding feature vector to be inputted into the second language model for processing. The embedding on the first token sequence may be implemented by invoking one layer of a neural network or a text embedding model. The embedding is to convert a discretized text into a dense continuous vector, that is, map the text to one point in a vector space. Finally, semantic information of the text in a semantic space is converted into a vector, so that the second language model subsequently encodes the vector.

Operation 103223: Invoke the second language model to encode the embedding feature vector of the first token sequence, to obtain a semantic feature vector of the first token sequence.

Based on the foregoing embodiment, after the embedding feature vector of the first token sequence is obtained through embedding, the second language model is invoked to encode the embedding feature vector, to obtain the semantic feature vector of each token (including the start token and the regular token) in the first token sequence. The second language model may be a BERT model having a 12-layer structure (BERT-12-Layer), or may be another text encoder or text encoding model having a multi-layer structure.

Operation 103224: Map a semantic feature vector of the start token in the semantic feature vector of the first token sequence, to obtain the matching score between the query text and the candidate citation text segment.

Considering that compared with other elements in the text pair, the semantic feature vector of the start token more fairly integrates semantic information of each element in the text pair, it may be regarded that the semantic feature vector of the start token includes semantic information of the entire text pair.

In this embodiment of this application, the semantic feature vector corresponding to the start token is inputted to a fully-connected layer for mapping, to obtain the matching score between the query text and the candidate citation text segment. The mapping may be seen as one prediction classification process. An activation function of the fully-connected layer may be a Softmax function, and is configured to map a corresponding semantic feature vector to a prediction classification probability. The classification probability is the matching score.

Operation 103225: Map a semantic feature vector corresponding to each regular token in the semantic feature vector of the first token sequence, to obtain the start probability of each element in the candidate citation text segment being the start position of the answer text segment and the end probability of each element in the candidate citation text segment being the end position of the answer text segment.

When the matching score between the query text and the candidate citation text segment is determined, additionally, which text segment in the candidate citation text segment in the text pairs may be used as the answer text segment is determined, that is, the start probability of each element in the candidate citation text segment to be suitable as the start position of the answer text segment and the end probability of each element in the candidate citation text segment to be suitable as the end position of the answer text segment are predicted. Specifically, the semantic feature vector corresponding to each regular token in the candidate citation text segments is inputted to the fully-connected layer for mapping. Two position vectors, a start position vector and an end position vector, are preset in the fully-connected layer. The inputted semantic feature vector corresponding to each regular token is multiplied with the start position vector and the end position separately to obtain inner product results, and then the two inner product results are respectively mapped to two classification probabilities through the activation function of the fully-connected layer. The activation function of the fully-connected layer may be a Softmax function, and the two classification probabilities are the corresponding start probability and end probability.

In this embodiment of this application, the start probability of the element in the candidate citation text segment being the start position of the answer text segment and the end probability of the element in the candidate citation text segment being the end position of the answer text segment are analyzed, and the start position and the end position of the answer text segment that correspond to the candidate citation text segment are determined based on the probabilities, reducing the redundancy of the answer text segment, making the answer text segment to have a higher relevance to the query text, thereby improving accuracy of determining the answer text segment.

Still refer to FIG. 3C. Operation 1033: Determine an optimal matching segment.

The matching score between the query text and each candidate citation text segment is determined, so that the candidate citation text segment corresponding to a maximum matching score may be determined as the optimal matching segment based on the matching score.

Operation 1034: Determine a start element and an end element in the optimal matching segment.

After the optimal matching segment is determined, which part of the text segment belongs to the answer text segment is determined from the optimal matching segment. Specifically, a start probability of each element in the optimal matching segment being the start position of the answer text segment is determined, and the element corresponding to a maximum start probability in the optimal matching segment is used as the start element of the answer text segment. Similarly, an end probability of each element in the optimal matching segment being the end position of the answer text segment is determined, and the element corresponding to a maximum end probability in the optimal matching segment is used as the end element of the answer text segment.

Operation 1035: Determine a part in the optimal matching segment that is located between the start element and the end element as the answer text segment matching the query text.

After the start element and the end element of the answer text segment are determined from the optimal matching segment, a text part between the start element and the end element that corresponds to the optimal matching segment is determined as the answer text segment matching the query text.

For example, the query text is “What is the temperature today,” and the optimal matching segment with the highest matching score determined from the candidate citation text segments is “The weather is great, the temperature is 20 degrees, and it's cloudy.” In this case, which part of the text segment may be used as the answer text segment needs to be determined from the optimal matching segment. When the matching score is predicted, the start probability of each element in the candidate citation text segment to be suitable as the start position of the answer text segment and the end probability of each element in the candidate citation text segment to be suitable as the end position of the answer text segment are also predicted. Therefore, if it is determined that the predicted start probability corresponding to the element “temperature” is the highest based on the predicted start probability corresponding to each element in the optimal matching segment, the element “temperature” is used as the start element of the answer text segment. Similarly, if it is determined that the predicted end probability corresponding to the element “degree” in the optimal matching segment is the highest based on the predicted end probability corresponding to each element in the optimal matching segment, the element “degree” is used as the end element of the answer text segment. Therefore, the start element and the end element of the answer text segment are determined from the optimal matching segment, and text parts between the start element “temperature” and the end element “degree” in the optimal matching segment are used as the answer text segment, so that it is determined that the answer text segment is “The temperature is 20 degrees.” Through this process, selection is finally performed on each text search result to obtain one answer text segment.

Still refer to FIG. 3A. Operation 104: Determine a relevance between the query text and each of the plurality of answer text segments, and determine the answer text segment corresponding to a maximum relevance as a reference text of the query text.

Selection is finally performed on each text search result to obtain one answer text segment, and selection is performed on the plurality of answer text segments. A specific selection process is: determining the relevance between the query text and each of the plurality of answer text segments, and determining the answer text segment corresponding to the maximum relevance as the reference text of the query text.

The relevance is an index configured for representing an association between the query text and the content of the answer text segment, and may be represented through a probability of a feature of the query text and a feature of the answer text segment belonging to the same type.

In some embodiments, referring to FIG. 3F, FIG. 3F is a schematic flowchart of a text processing method according to an embodiment of this application. The “determining a relevance between the query text and each of the plurality of answer text segments” in operation 104 shown in FIG. 3A may be implemented through operation 1041 to operation 1044 in FIG. 3F. Details are described below.

Operation 1041: Use each element in the query text, the answer text segment, and the title text as one regular token, and concatenate the regular tokens into a second token sequence.

For each answer text segment, each element in the query text and the answer text segment is used as one regular token, and then the regular tokens are concatenated into the second token sequence. The regular tokens between the query text and the answer text segment are connected by a separator token, and the start token is inserted into a head of the second token sequence.

In some embodiments, the title text of the answer text segment may further be extracted as a part of the second token sequence. Therefore, each element in the query text, the answer text segment, and the title text may be used as one regular token, and then the regular tokens are concatenated into the second token sequence. Generally, a semantic feature of the title text is strong, so that it facilitates subsequent determining of the relevance and improving the accuracy of relevance calculation.

Operation 1042: Perform embedding on the second token sequence, to obtain an embedding feature vector of the second token sequence.

Based on the foregoing embodiment, after the second token sequence is obtained, embedding is performed on the second token sequence, to obtain the embedding feature vector of the second token sequence for subsequent encoding of the second language model. The embedding on the second token sequence may be implemented by invoking one layer of the neural network (the fully-connected layer), may be implemented through a multi-layer perceptron (MLP), or may be implemented by using other text embedding models.

Operation 1043: Invoke a third language model to encode the embedding feature vector of the second token sequence, to obtain a semantic feature vector of the second token sequence.

Based on the foregoing embodiment, the third language model is invoked to encode the embedding feature vector of the second token sequence, to obtain the semantic feature vector of the second token sequence. The semantic feature vector of the second token sequence is a semantic feature vector corresponding to the start token of the second token sequence since a semantic encoding result corresponding to the start token may represent a semantic encoding result of the entire second token sequence. The third language model herein may be a cross-encoder, a BERT model, or a non-cross-encoder or a text encoder with no restrictions on network layers and network structure.

Operation 1044: Map the semantic feature vector of the second token sequence, to obtain the relevance between the query text and the answer text segment.

Based on the foregoing embodiment, after the semantic feature vector corresponding to the start token of the second token sequence is used as the semantic feature vector of the entire second token sequence, the multi-layer perceptron is invoked to map the semantic feature vector. Specifically, the semantic feature vector corresponding to the start token is mapped to a predicted classification probability through the multi-layer perceptron. The predicted classification probability is the relevance between the query text and the answer text segment, and denoted as S_{q,t+p}.

Based on the foregoing embodiment, the relevance S_{q,t+p} between the query text and each answer text segment is determined, and the answer text segment corresponding to the maximum S_{q,t+p} is determined as the reference text corresponding to the query text.

Still refer to FIG. 3A. Operation 105: Invoke a first language model based on the query text and the reference text, to obtain a reply text of the query text.

Based on the foregoing embodiment, the reference text corresponding to the query text is finally obtained. In this case, the first language model may be invoked to process the query text and the reference text, to predict the reply text corresponding to the query text from the reference text.

In some embodiments, referring to FIG. 3G, FIG. 3G is a schematic flowchart of a text processing method according to an embodiment of this application. Operation 105 shown in FIG. 3A may be implemented through operation 1051 and operation 1052 in FIG. 3G. Details are described below.

Operation 1051: Invoke the first language model based on the query text and the reference text, to perform prediction processing on the query text and the reference text, to determine a start element and an end element of the reply text that are in the reference text.

After the reference text is determined from the answer text segment, the reference text may be used as a reference material to guide the first language model to predict an inputted reply text, to generate the corresponding reply text. Specifically, the query text and the reference text are inputted into the first language model for prediction processing, to determine the start element and the end element of the reply text in the reference text, to obtain a start position and an end position of the reply text in the reference text.

In some embodiments, referring to FIG. 3H, FIG. 3H is a schematic flowchart of a text processing method according to an embodiment of this application. Operation 1051 shown in FIG. 3G may be implemented through operation 10511 to operation 10515 in FIG. 3H. Details are described below.

Operation 10511: Use each element in the query text and the reference text as one regular token, and concatenate the regular tokens into a third token sequence.

In some embodiments, since the language model cannot directly perform prediction based on an original text, the semantic feature vector of the text still needs to be determined. First, an embedding feature vector of the text is obtained, each element in the query text and the reference text is used as one regular token, and then the regular tokens are concatenated into the third token sequence. The regular tokens between the query text and the reference text are connected by a separator token, and then the start token (CLS) is inserted into a head of the third token sequence.

Operation 10512: Perform embedding on the third token sequence, to obtain an embedding feature vector of the third token sequence.

Based on the foregoing embodiment, embedding is performed on the third token sequence obtained through concatenation, to obtain the embedding feature vector of the third token sequence for subsequent encoding by the first language model. Similarly, the embedding on the third token sequence may be implemented by invoking one layer of the neural network (the fully-connected layer), may be implemented through the multi-layer perceptron, or may be implemented by using other text embedding models.

Operation 10513: Invoke the first language model to encode the embedding feature vector of the third token sequence, to obtain a semantic feature vector of each regular token in the third token sequence.

Based on the foregoing embodiment, an encoder of the first language model is invoked to encode the embedding feature vector of the third token sequence, to obtain the semantic feature vector corresponding to each regular token in the third token sequence. The first language model may be various types of large language models, capable of fully learning and understanding a semantic feature of a given text, and generating a text matching the given text based on a semantic feature of a context of the given text.

Operation 10514: Map the semantic feature vector corresponding to each regular token, to obtain a start probability of each element of the reference text being the start element of the reply text and an end probability of each element of the reference text being the end element of the reply text. The start probability of an element being the start element of the reply text is also referred to as a “start element probability” of the element, and the end probability of an element being the end element of the reply text is also referred to as an “end element probability” of the element.

Based on the foregoing embodiment, after the semantic feature vector of each regular token in the third token sequence is obtained, considering that in this embodiment of this application, the existing reference text is used as the reference material of the query text, only the first language model needs to be used to predict the reply text matching the query text from the reference text. Specifically, the semantic feature vector of each regular token in the third token sequence is mapped to two predicted classification probabilities. Through a preset start position vector and a preset end position vector in the fully-connected layer of the first language model, the semantic feature vector corresponding to each regular token is multiplied with the start position vector and the end position vector separately, to obtain two inner products, and then the two inner product results are respectively mapped to two classification probabilities through the activation function of the fully-connected layer. The two classification probabilities are respectively the start probability of the element corresponding to the regular token of the reference text being the start element of the reply text and the end probability of the element corresponding to the regular token of the reference text being the end element of the reply text. The activation function of the fully-connected layer may be a normalization function (Softmax function).

Operation 10515: Determine the element corresponding to the maximum start probability as the start element of the reply text, and determine the element corresponding to the maximum end probability as the end element of the reply text.

After two classification probabilities of the corresponding element of each regular token in the third token sequence are determined, in the third token sequence, the element corresponding to the maximum start probability is used as the start element of the reply text, and the element corresponding to the maximum end probability is used as the end element of the reply text. In this way, a specific position of the reply text in the reference text is determined.

Still refer to FIG. 3G. Operation 1052: Determine a text between the start element and the end element of the reference text as the reply text of the query text.

After the specific position of the reply text in the reference text is determined, a text segment between the start element and the end element in the reference text is determined as the reply text, and is used as a finally predicted text of the first language model, that is, a generated text of the first language model.

For example, the query text is “What is the temperature today,” and the corresponding reference text is “It's sunny today, and the temperature is 20 degrees.” Each character of the query text and the reference text is used as one regular token, and the regular tokens are concatenated by the separator token, to obtain the third token sequence. In addition, the start token is inserted into the head of the third token sequence, to obtain “[CLS] What is the temperature today, [SEP] It's sunny today, and the temperature is 20 degrees.” Then, embedding is performed on the third token sequence, to obtain the corresponding embedding feature vector, and the embedding feature vector is inputted into the first language model for encoding, to obtain the semantic feature vector corresponding to each regular token. Further, the semantic feature vector of each regular token is mapped to the two classification probabilities, that is, the start probability used as the start position of the reply text and the end probability used as the end position of the reply text. In this way, it is determined that the start probability obtained by mapping the semantic feature vector corresponding to the element “temperature” in the reference text is the largest, and the element “temperature” may be used as the start position of the reply text. Correspondingly, the end probability obtained by mapping the semantic feature vector corresponding to the element “degree” in the reference text is the largest, and the element “degree” may be used as the end position of the reply text. Therefore, the text between the element “temperature” and the element “degree” in the reference text is used as the reply text, that is, “The temperature is 20 degrees” is used as the reply text of the query text “What is the temperature today.”

According to this embodiment of this application, a plurality of latest text search results prioritizing timeliness that are generated by the query text invoking the search engine interface are obtained; and then the related answer text segments matching the query text are extracted from the text search results, and selection is performed on the answer text segments, to determine the text segment having a highest relevance with the query text from the plurality of answer text segments as the reference text and use the text segment as the reference material for the first language model to predict the generated text. Then, the first language model is invoked to predict the reply text matching the query text from the reference text, so that the first language model may answer to the query text based on a latest reference material, to generate the corresponding reply text. In addition, the first language model predicts the reply text from the reference text generated in a fixed manner, so that the controllability of the content generated by the first language model is increased, and the timeliness of the generated content is improved.

In some embodiments, the first language model, the second language model, and the third language model may be integrated into one large language model, and the first language model, the second language model, and the third language model are trained separately.

In some embodiments, referring to FIG. 31, FIG. 31 is a schematic flowchart of a text processing method according to an embodiment of this application. After operation 105 shown in FIG. 3A, operation 106 to operation 108 in FIG. 31 may further be performed. Details are described below.

Operation 106: Obtain a plurality of candidate citation texts.

In the related art, after the language model generates the reply text based on the query text, considering that there are problems that low authenticity and fabrication may exist in the answer text, the related citation text is added after the corresponding reply text as a text source of the reply text, to improve the authenticity of the reply text generated by the first language model and resolve the problem of fabrication. The corresponding candidate citation text is obtained through the reply text. The candidate citation text includes the material configured for citation in the reply text. A method for obtaining the candidate citation text may be invoking, based on the reply text, the search engine interface to search for text search content related to the reply text, or invoking a text generation model to randomly generate a plurality of texts based on semantics of the reply text.

Operation 107: Segment the reply text into the plurality of answer text segments, and segment each candidate citation text into a plurality of citation text segments.

Based on the foregoing embodiment, after the candidate citation text is obtained, whether the candidate citation text matches the reply text is determined. Only when the candidate citation text matches the reply text, the candidate citation text can be used as the citation material. A method for determining that the candidate citation text matches the reply text is determining a text similarity between the candidate citation text and the reply text.

In this embodiment of this application, considering that text scales of the reply text and the candidate citation text may be large, and a calculation amount of directly determining the text similarity is excessively large, the reply text is segmented into the plurality of answer text segments longer than the fixed length, and each candidate citation text is segmented into the plurality of citation text segments longer than the fixed length. This is implemented by determining the text segment similarity. Alternatively, the citation material may be added to each answer text segment of the reply text, as the citation text.

Operation 108: Determine at least one citation text segment each matching one of at least one answer text segment, and insert the at least one citation text segment each matching one of the at least one answer text segment into the reply text. A citation text segment matching an answer text segment is also referred to as a “matching citation text segment.”

In some embodiments, referring to FIG. 3J, FIG. 3J is a schematic flowchart of a text processing method according to an embodiment of this application. The “determining a citation text segment matching at least one answer text segment” in operation 108 shown in FIG. 31 may be implemented through operation 1081A and operation 1082A. Details are described below.

Operation 1081A: Combine the plurality of answer text segments and the plurality of citation text segments in pairs, to form a plurality of candidate text pairs.

The reply text and the candidate citation text are separately segmented, to obtain a plurality of text segments. It is considered that citation content needs to be added to each answer text segment in the reply text. Therefore, each answer text segment is separately combined with each citation text segment, to form a plurality of candidate text pairs. In other words, the plurality of answer text segments and the plurality of citation text segments are combined in pairs, so that a similarity between the answer text segment and the citation text segment in the candidate text pair can be determined subsequently.

For example, a reply text is segmented to obtain 20 answer text segments, and for 10 candidate citation texts, each candidate citation text is segmented into five citation text segments. In this case, after each answer text segment and each citation text segment are combined in pairs, a quantity of finally obtained candidate text pairs is 1000 (20×10×5).

Operation 1082A: Identify at least one matching text pair from the plurality of candidate text pairs, and determine that the citation text segment in the matching text pair matches the answer text segment in the matching text pair.

After the answer text segments and the citation text segments are combined into the plurality of candidate text pairs, whether the answer text segment matches the citation text segment may be identified by determining a similarity between two text segments in the candidate text pair, to identify at least one matching text pair from the plurality of candidate text pairs, so that it can be determined that the citation text segment in the matching text pair matches the answer text segment in the matching text pair.

In some embodiments, considering that there are a large quantity of answer text segments and citation text segments, and a quantity of formed candidate text pairs is excessively large, to improve the text processing efficiency and reduce the calculation amount in subsequent operations, before the matching text pair is identified from the plurality of candidate text pairs, initial filtering may be performed on the plurality of candidate text pairs, to filter out apparently mismatched or unimportant candidate text pairs.

In some embodiments, a method of performing initial filtering on the candidate text pairs may be text keyword identification. In the answer text segment, citation content is generally added only for a text having a keyword. Since the keyword expresses most semantic information, and other non-keyword texts are unimportant texts in the texts, the citation content does not need to be added to these unimportant texts. Therefore, initial filtering may be performed to filter out these candidate text pairs having no keyword.

A specific filtering process based on the text keyword identification is: for each candidate text pair, invoking a keyword identification model to perform keyword identification on the answer text segment and the citation text segment in the candidate text pair respectively. When the keyword is not identified in at least one of the answer text segment and the citation text segment in the candidate text pair, it indicates that both the answer text segment and the citation text segment are unimportant texts having no key semantic information, or when the keyword is not identified in either the answer text segment or the citation text segment, it indicates that semantics of the unimportant text is apparently mismatched with semantics of the candidate text pair, so that the unimportant text and apparently unmatched semantics of the candidate text pair are directly filtered out. The keyword identification model may be a text rank algorithm, a term frequency-inverse document frequency (TF-IDF) method, a rapid automatic keyword extraction (RAKE) algorithm, or a combination of the three methods.

In some embodiments, the method of performing initial filtering on the candidate text pairs is based on a similarity matching method of a text segment embedding (sentence embedding). A specific filtering process is: for each candidate text pair, invoking a text encoding model to encode the answer text segment and the citation text segment in the candidate text pair respectively, to obtain an embedding feature vector of the answer text segment and an embedding feature vector of the citation text segment, where the embedding feature vector of the answer text segment may be an embedding feature vector of an entire segment, or may be an embedding feature vector of a sub-segment (where the answer text segment is further divided); and the embedding feature vector of the citation text segment may be an embedding feature vector of an entire segment, or may be an embedding feature vector of a sub-segment (where the citation text segment is further divided). Then, a similarity between the embedding feature vector of the answer text segment and the embedding feature vector of the citation text segment is determined. The similarity between the embedding feature vectors may be a similarity between the embedding feature vectors of the entire segments, or may be a similarity between the embedding feature vectors of the sub-segments. Therefore, a similarity between each candidate text pair may be determined. In this embodiment of this application, a similarity threshold is set. For example, if the similarity of the candidate text pair is less than the similarity threshold, the corresponding candidate text pair is deleted.

For example, in the candidate text pair, the embedding feature vector of the answer text segment may be the embedding feature vector of the entire segment, for example, an embedding feature vector A, and the embedding feature vector of the citation text segment in the corresponding candidate text pair may be the embedding feature vector of the entire segment, for example, an embedding feature vector B. Then a similarity between the embedding feature vector A and the embedding feature vector B may be determined, and when the similarity is less than the similarity threshold, the corresponding candidate text pair is deleted.

In some other examples, the answer text segment in the candidate text pair may be further divided first, to obtain a plurality of reply text sub-segments, and then the text encoding model is invoked to encode the plurality of reply text sub-segments, to obtain embedding feature vectors, which are denoted as A1, A2, . . . , and An, of the reply text sub-segments. Correspondingly, the citation text segment in the candidate text pair is further divided, to obtain a plurality of citation text sub-segments, and then the text encoding model is invoked to encode the plurality of citation text sub-segments, to obtain embedding feature vectors, which are denoted as B1, B2, . . . , and Bn, of the citation text sub-segments. In addition, a similarity between A1 and B1, a similarity between A2 and B2, and a similarity between An and Bn are determined respectively. When one similarity is less than the similarity threshold, it indicates that the answer text segment does not match the citation text segment, and the corresponding candidate text pair is deleted.

In this embodiment of this application, before the matching text pair is identified from the plurality of candidate text pairs, initial filtering may be performed on the plurality of candidate text pairs, to first filter out the apparently mismatched or unimportant candidate text pairs, thereby reducing the calculation amount in subsequent operations and improving the text processing efficiency.

In some embodiments, referring to FIG. 3K, FIG. 3K is a schematic flowchart of a text processing method according to an embodiment of this application. In operation 1082A shown in FIG. 3J, the “identifying at least one matching text pair from the plurality of candidate text pairs” may be implemented through operation 10821A to operation 10825A in FIG. 3J. Details are described below.

Operation 10821A: Invoke a fourth language model to respectively encode the answer text segment and the citation text segment in the candidate text pair, to obtain the embedding feature vector of the answer text segment and the embedding feature vector of the citation text segment.

In some embodiments, determining the similarity between the two text segments in the candidate text pair may be implemented by invoking the language model. For each candidate text pair, the fourth language model is invoked to respectively encode the answer text segment and the citation text segment in the candidate text pair, to obtain the embedding feature vector of the answer text segment and the embedding feature vector of the citation text segment. The fourth language model may be a text-based BERT model (Sentence-BERT) or another text encoding model.

Operation 10822A: Perform pooling processing on the embedding feature vector of the answer text segment and the embedding feature vector of the citation text segment respectively, to obtain a semantic feature vector of the answer text segment and a semantic feature vector of the citation text segment.

Since a text length or a text scale of the answer text segment and a text length or a text scale of the citation text segment may be greatly different, for the embedding feature vector of the answer text segment and the embedding feature vector of the citation text segment, pooling processing may further be performed on the embedding feature vectors through a pooling layer, so that a dimension of the embedding feature vector of the answer text segment is the same as a dimension of the embedding feature vector of the citation text segment, thereby further facilitating subsequent determining of a vector similarity and reducing the calculation amount. The pooling layer obtains the semantic feature vector of the answer text segment and the semantic feature vector of the citation text segment after pooling processing is performed.

Operation 10823A: Concatenate the semantic feature vector of the citation text segment and the semantic feature vector of the answer text segment, to obtain a fused feature vector of the candidate text pair.

Based on the foregoing embodiment, after the semantic feature vector of the answer text segment and the semantic feature vector of the citation text segment are determined, considering that the dimensions of the two semantic feature vectors are the same, the two semantic feature vectors may be directly concatenated, to obtain the fused feature vector of the text pair.

Operation 10824A: Map the fused feature vector, to obtain a semantic similarity between the answer text segment and the citation text segment in the candidate text pair.

Based on the foregoing embodiment, after the fused feature vector of each candidate text pair is obtained, one layer of the neural network (the fully-connected layer) or the multi-layer perceptron may be invoked to perform mapping on the fused feature vector, to map the fused feature vector to the classification probability. The classification probability may be used as the semantic similarity between the answer text segment and the citation text segment in the candidate text pair. The activation function of the fully-connected layer may be a Softmax function.

In some embodiments, the semantic feature vector of the answer text segment and the semantic feature vector of the citation text segment may not be concatenated. In other words, the fused feature vector does not need to be constructed, and the two semantic feature vectors are directly processed. For example, a cosine-similarity or an editing distance is calculated as the semantic similarity.

Operation 10825A: Determine a candidate text pair whose semantic similarity is greater than a semantic similarity threshold as the matching text pair.

For each candidate text pair, after the semantic similarity between the answer text segment and the citation text segment in the candidate text pair is separately determined, selection is performed on the candidate text pairs through a preset semantic similarity threshold, and a text pair whose semantic similarity is greater than the semantic similarity threshold is determined as the matching text pair. The semantic similarity threshold may be set based on a quantity of the candidate text pairs, and the set semantic similarity threshold is positively correlated with the quantity of the candidate text pairs. In other words, a larger quantity of candidate text pairs indicates a larger semantic similarity threshold, and a smaller quantity of candidate text pairs indicates a smaller semantic similarity threshold. For example, when the quantity of the candidate text pairs is excessively large, and there are 1000 candidate text pairs, the semantic similarity threshold may be set to be high, for example, the semantic similarity threshold is set 0.9; and when the quantity of the text pairs is small, and there are 500 candidate text pairs, the semantic similarity threshold may be set to be low, for example, the semantic similarity threshold is set 0.7.

In some embodiments, referring to FIG. 3L, FIG. 3L is a schematic flowchart of a text processing method according to an embodiment of this application. “inserting the at least one citation text segment each matching one of the at least one answer text segment into the reply text” in operation 108 shown in FIG. 31 may be implemented through operation 1081B and operation 1082B. Details are described below.

Operation 1081B: Insert, in response to a quantity of the at least one answer text segment being less than or equal to a first quantity threshold, the at least one citation text segment each matching one of the at least one answer text segment at a position after the corresponding answer text segment respectively.

In some embodiments, the matching text pair is determined, and the citation text segment in the matching text pair may be used as the citation material of the corresponding answer text segment. Specifically, the answer text segment matching the citation text segment is determined from the reply text based on the matching text pair. In this way, a citation position of each citation text segment in the reply text may be determined.

Considering that there may be a large quantity of answer text segments in the reply text, adding the citation material to each answer text segment causes excessive calculation costs. In this embodiment of this application, the first quantity threshold of the answer text segment is set. When a quantity of answer text segments in the reply text is less than or equal to the first quantity threshold, in the reply text, the citation text segments is concatenated after the corresponding answer text segment as the citation material based on the matching text pair. A representation form of the citation material may be a specific symbol identifier, such as a text superscript or a text subscript, or some citation symbols, such as “[ ]” or “| |,” may be used. The corresponding citation material may be rapidly positioned and found through these citation symbols.

Operation 1082B: Insert, in response to a quantity of the at least one answer text segment being greater than the first quantity threshold, the citation text segments respectively matching the at least one answer text segment into an end of the reply text uniformly.

Based on the foregoing embodiment, when the quantity of answer text segments in the reply text is greater than the first quantity threshold, the citation text segments respectively matching the at least one answer text segment are sequentially inserted into the end of the entire reply text as the citation material of the reply text. There may be no sequential order of inserting the citation text segments.

In some embodiments, considering that each answer text segment and each citation text segment are combined in pairs, one answer text segment may have a plurality of citation text segments that may be combined, that is, the answer text segment may have a plurality of citation materials. However, if there may be a large quantity of citation materials, it may hinder the presentation of the reply text, and the increase the text scale and reading volume. Therefore, in this embodiment of this application, before the citation text segment matching the answer text segment is inserted, a second quantity threshold is set to limit the quantity of citation materials of the answer text segment. Descending sorting is performed based on a similarity between the at least one answer text segment and the citation text segment matching the at least one answer text segment when the quantity of citation text segments matching the at least one answer text segment is greater than the second quantity threshold, and a set quantity or a set proportion of citation text segments matching the answer text segment is used as a to-be-inserted text segment starting from a head in a descending sorting result. Finally, the to-be-inserted text segment is inserted into the position after the corresponding answer text segment that the to-be-inserted text segment matches.

For example, six citation text segments match one answer text segment. The six citation text segments may be sequentially inserted after the answer text segment based on a descending order of the semantic similarity between the citation text segment and the answer text segment. Therefore, a quantity of citation texts of the answer text segment is six. In this case, the second quantity threshold is set to 2, and the quantity of citation text segments is greater than the second quantity threshold. A specified quantity (which may be, for example, two) or a preset proportion (which may be, for example, a half or 50%) of citation text segments are used as the to-be-inserted text segment. Finally, the to-be-inserted text segment is inserted into the position after the answer text segment which the to-be-inserted text segment matches.

In some embodiments, operation 1081B and operation 1082B shown in FIG. 3L may be performed in parallel, and there is no execution sequence.

According to this embodiment of this application, a text having a high similarity with the generated text (that is, the reply text) of the first language model is selected from the provided candidate citation text and used as the citation material, to add the citation content to the related answer text segments in the generated text. Therefore, problems that it is difficult to determine the authenticity of the content and to further understand the content in depth since content generated by the first language model does not have the citation information can be resolved. In addition, the citation content is used as the reference material for the generated text of the first language model, to improve the authenticity and credibility of the generated text of the first language model and resolve the problems that low factuality, poor credibility, and fabrication exist in original generated text.

The following describes an example application in an actual application scenario in the embodiments of this application.

In some application scenarios such as a search system and a dialog system, in the related art, a large language model is usually used to learn and understand a natural language, and automatically generate a high-quality text based on a given context or a question. For example, a plurality of functions such as code writing, passage generation, and role play may be implemented in an application scenario, to significantly improve the information obtaining efficiency of searching and the dialog quality. However, generally, the large language model is usually based on a transformer encoder architecture, where multi-head attention layers are stacked in a very deep neural network, and a quantity of parameters may reach hundreds of millions, making model deployment and training difficult. However, the large language model does not have an information obtaining capability and a self-updating capability. When a model update frequency is low, a text can be generated only in a fixed existing natural language scope, resulting in poor controllability. Since the model cannot incorporate and learn new natural language knowledge in time, information disconnection between a generated text and a given text is easily caused. As a result, finally generated text content has a problem of poor timeliness. However, based on the poor timeliness, problems such as insufficient factuality, low credibility, and fabrication also exist in the generated text. Consequently, a performance effect of the large language model is affected.

Based on this scenario, an embodiment of this application provides a text processing method. Search information having timeliness is collected to select corresponding an answer text as a reference text of a model. Then a large language model is guided to generate controllable text content based on a given text, so that the model learns new search knowledge through the reference text in time, thereby improving the timeliness of the generated text. Based on this, a text having a high similarity with the generated text is further selected from the provided candidate text as the citation text, and citation content is added to generated text content, thereby improving the authenticity and credibility of the generated text and resolving the problems that low factuality, poor credibility, and fabrication exist in original generated text.

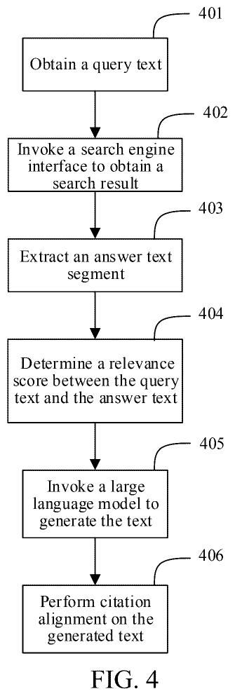

Referring to FIG. 4, FIG. 4 is a processing flowchart of a text processing method according to an embodiment of this application. Specifically, the text processing method includes six operations, such as obtaining a query text, obtaining a query result, extracting an answer text segment, determining a relevance score between the query text and the answer text segment, invoking a large language model to generate a text, and performing citation alignment on a generated text. Specific implementation of each operation is described in detail below with reference to FIG. 4.

Refer to FIG. 4. Operation 401: Obtain a query text.

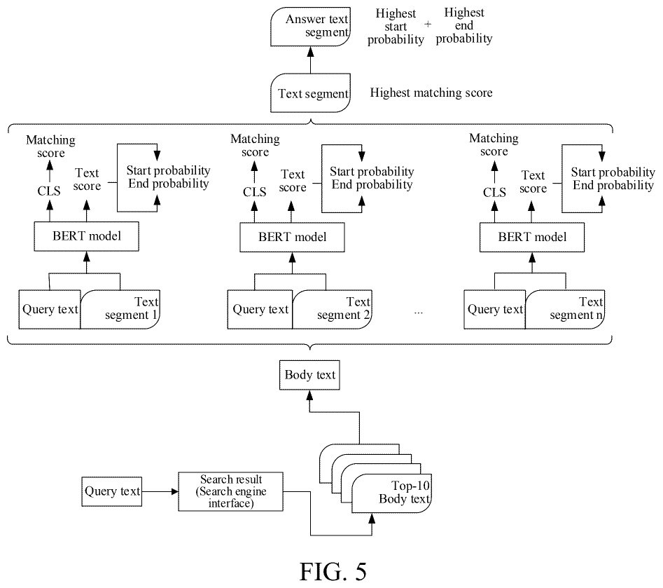

The query text is generally related to a corresponding application scenario. For example, a dialog scenario may be a search keyword related to a topic of the dialog scenario or a search item including a plurality of search keywords. The query text is configured for obtaining latest search information to extract a corresponding answer text segment, to provide a corresponding reference text for a large language model. For a processing framework diagram of obtaining the latest search information and extracting the answer text segment based on the query text, referring to FIG. 5, FIG. 5 is a processing process diagram of extracting an answer text segment according to an embodiment of this application.

Still refer to FIG. 4. Operation 402: Invoke a search engine interface to obtain a search result.

As shown in FIG. 5, after the query text is obtained, the related search engine interface may be invoked to obtain the search result, where the search engine interface may be a related terminal browser, a search server, or another engine and function interface having a search function. The search result is generally a pure text, including a body text and a corresponding text title.

In some embodiments, a sorting manner of search results of the search engine interface is sorting the search results based on generation time, that is, search information with the latest generation time is sorted at the top, and then, 10 related text search results with the latest generation time are obtained from the search engine interface based on a reverse order of the generation time, that is, “top-10 body texts” shown in FIG. 5.

Still refer to FIG. 4. Operation 403: Extract an answer text segment.

In the body text included in the text search result, only some texts are answers to the query text, and other texts are valueless text information irrelevant to the query text. The reply text (passage) segment is first extracted from the text search result.

As shown in FIG. 5, the 10 related text search results (top-10 body texts) are used as the body text. Each inputted body text is first segmented into text segments each having a length of 500, which are shown as a text segment 1, a text segment 2, . . . , a text segment n in FIG. 5. Then, each text segment and the query text is inputted into a 12-layer BERT model (that is, a BERT-12-layer, equivalent to the second language model described above), and a matching score (QS Score) between each text segment and the query text is calculated through the BERT model. Since the text cannot be inputted into the BERT model for processing, each text element in the query text and the text segment is first used as a regular token, all regular tokens are concatenated through a start token (CLS) and a separator token (SEP), and then embedding is performed, to obtain an embedding feature vector of the concatenated text. The embedding feature vector is inputted into the 12-layer BERT model for encoding, to obtain a semantic feature vector. A semantic feature vector corresponding to the start token (CLS) is inputted into a fully-connected layer, to be mapped to a matching score (QS Score) between the text segment and the query text. An activation function of the fully-connected layer may be a Softmax function. When the BERT model is invoked to encode the embedding feature vector of the concatenated text, a start probability (start score) of each text element of the text segment in the concatenated text to be suitable as a start element of the answer text segment and an end probability (end score) of each text element of the text segment in the concatenated text to be suitable as an end element of the answer text segment are predicted. Specifically, after an embedding feature vector (token represent, token rep) of each text element in the text segment is encoded, semantic feature vectors obtained through encoding are respectively mapped to, through the fully-connected layer, a corresponding probability of each text element being the start element of the answer text segment and a corresponding probability of each element being the end element of the answer text segment.

As shown in FIG. 5, though foregoing operations, after each text segment and the query text are concatenated, a text segment having a highest matching score (max QS score) in the query text is determined from the text segment. In the text segment, an element of a highest start probability (max start score) that is suitable as the start element of the answer text segment is selected and determined as the start element of the answer text segment; an element of a highest end probability (max end score) that is suitable as the end element of the answer text segment is selected and determined as the end element of the reply text; and finally, a text between the start element and the end element in the text segment is used as a final answer text segment. Therefore, 10 text search results (top-10 body text), that is, 10 body texts, may be extracted to obtain corresponding 10 answer text segments.

Still refer to FIG. 4. Operation 404: Determine a relevance score between the query text and the answer text segment.

After the 10 answer text segments are obtained, the answer text segments related to the query text are selected as the reference text of the large language model. Specifically, relevance scores between the query text and the answer text segments are respectively determined.

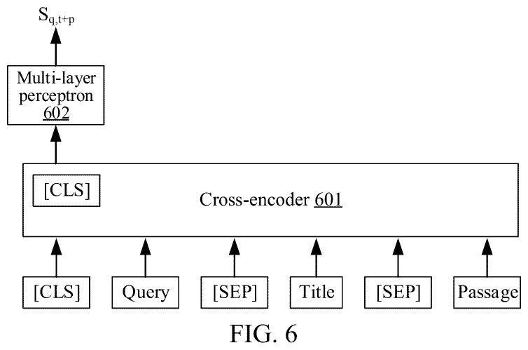

For a process of determining the relevance score between the query text and the answer text segment, referring to FIG. 6. FIG. 6 is a process diagram of determining a relevance score between a query text and an answer text segment according to an embodiment of this application. First, for each answer text segment, each element in the query text (query shown in FIG. 6), each element in a title (title shown in FIG. 6) of the answer text segment, and each element in the answer text segment (passage shown in FIG. 6) are used as regular tokens. The regular tokens between the query text, the title, and the answer text segment are concatenated through a separator token (SEP), to obtain a concatenated text token sequence. A start token (CLS) is inserted into a head of the concatenated text token sequence, and embedding is performed on the concatenated text token sequence. After the embedding feature vector of the concatenated text is obtained, the embedding feature vector of the concatenated text is inputted into a cross-encoder 601 for encoding, to obtain a corresponding semantic feature vector. The cross-encoder herein is equivalent to the foregoing third language model. Finally, a semantic feature vector corresponding to the start token (CLS) is inputted into a multi-layer perceptron 602 and is mapped to the relevance score between the query text and the answer text segment, and the relevance is denoted as S_{q,t+p}. The relevance score is a relevance score fitted by the multi-layer perceptron.

In some embodiments, the cross-encoder does not specifically limit a model type and a topology structure of a deep neural network, and may be replaced with various other model structures. For example, a non-cross-encoder may also be used, a quantity of layers of the network model is increased or decreased according to an actual requirement of the model, or a structure of the deep network model is adjusted. The cross-encoder is trained through 50 million text pairs formed by combining the query texts and the answer text segments, and training data may be obtained through data mining or manual precise annotation.

After the relevance scores between the 10 answer text segments and the query texts are respectively determined, the answer text segments may be selected through a relevance score threshold, an answer text segment whose relevance score is less than the relevance score threshold is selected, and remaining answer text segments are used as the reference text of the large language model.

Still refer to FIG. 4. Operation 405: Invoke the large language model to generate the text.

After the reference text is determined, the reference text and the query text are inputted into the large language model together for prediction. The large language model herein is equivalent to the foregoing first language model. A specific prediction process is: using each element in the reference text and the query text as the regular token, concatenating the regular tokens between the reference text and the query text through the separator token (SEP) to form a concatenated sequence, inserting the start token (CLS) into a head of the concatenated sequence, and performing embedding on the concatenated sequence, to obtain an embedding feature vector of the concatenated sequence. Then, the embedding feature vector is inputted into the large language model for encoding, to finally obtain the semantic feature vector of the concatenated sequence. The semantic feature vector of each element is mapped to the start probability of the start element of the reply text of the query text and the end probability of the end element. In addition, the element corresponding to a maximum start probability is determined as the start element of the reply text, and the element corresponding to a maximum end probability is determined as the end element of the reply text. Therefore, the start position and the end position of the reply text of the query text in the reference text may be predicted. A text between the start position and the end position of the reference text is determined as the reply text. In other words, the text is used as the generated text of the large language model for the query text and outputted.

According to this embodiment of this application, a plurality of latest text search results prioritizing timeliness that are generated by the query text invoking the search engine interface are obtained; and then the related answer text segments matching the query text are extracted from the text search results, and selection is performed on the answer text segments, to determine the text segment having a highest relevance with the query text from the plurality of answer text segments as the reference text of the large language model. Then, the large language model is invoked to predict the reply text corresponding to the query text from the reference text, to generate the corresponding text, thereby improving the controllability of the content generated by the large language model and improving the timeliness of the generated content.

Still refer to FIG. 4. Operation 406: Perform citation alignment on the generated text.

Considering that the generated text of the large language model in the related art may have problems such insufficient factuality, low credibility, and fabrication, a performance effect of the large language model may be affected. According to this embodiment of this application, a text having a high similarity with the generated text is selected from the provided candidate text as the citation text, and citation content is added to generated text content, thereby implementing the citation alignment, improving the authenticity and credibility of the generated text, and resolving the problems that low factuality, poor credibility, and fabrication exist in original generated text.

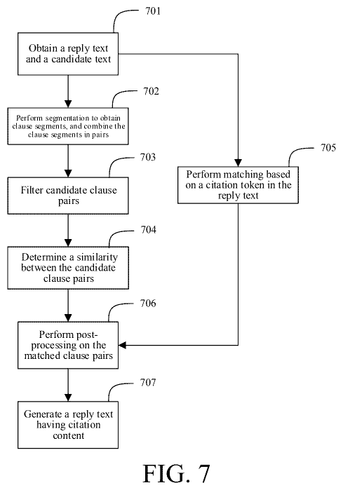

Referring to FIG. 7, FIG. 7 is a processing flowchart of performing citation alignment on a generated text according to an embodiment of this application. A specific process of citation alignment is described with reference to FIG. 7.

Operation 701: Obtain a reply text and a candidate text. In addition, operation 702 and operation 705 are performed.

After predicting the corresponding reply text based on query text, a large language model may obtain a search text related to the query text through search, or invoke a text mining model based on the query text to mine and obtain the search text, and determine the search text as a candidate text. The candidate text is used as a citation text of the reply text.

Operation 702: Perform segmentation to obtain clause segments, and combine the clause segments in pairs.

After the reply text and the candidate text are obtained, the reply text and the candidate text are respectively segmented into a plurality of clauses, that is, the text is segmented into a plurality of to-be-matched segments. The to-be-matched segments need to include basic semantic information of the text. A segment length cannot be excessively short, for example, the segment length cannot be less than 10. Because when a segment is excessively short, reference information used by a subsequent module is excessively limited, the subsequent module is invalidated, and a semantic extraction effect cannot be ensured. A specific process is: segmenting the text by using punctuations, if a length of a segment after segmentation is less than 10, combining the segment with an adjacent segment into a longer segment, and repeating the foregoing process until the segmentation ends when lengths of all to-be-matched segments exceed 10 or the to-be-matched segments already include all input texts.

After the segmentation process is completed, two groups of to-be-matched segments corresponding to the reply text and the candidate text are obtained. The two groups of segmented clauses (to-be-matched segments) are combined in pairs, to obtain a plurality of candidate clause pairs. Specifically, each segmented clause of the reply text is combined with each segmented clause in the candidate text one by one, to obtain the plurality of candidate clause pairs.

For example, the reply text is segmented into 20 clauses, and there are 10 candidate texts in total. Each candidate text is segmented into five clauses. In this case, after the two groups of segmented clauses are paired one by one, an obtained total quantity of candidate clause pairs is 1000 (20×10×5).

Operation 703: Filter the candidate clause pairs.

The filtering on matched clause pairs is mainly performing initial filtering on the obtained plurality of candidate clause pairs, to filter out an apparently mismatched or unimportant sentence and reduce a calculation amount in a subsequent processing process.

In some embodiments, a filtering method may be key segment identification based on keywords. Specifically, some unsupervised identification algorithms are invoked to respectively identify keywords of clauses corresponding to the reply text and the candidate text in the candidate clause pairs, and an identified clause including the keywords is determined as a key text segment. In all candidate clause pairs, if one of the candidate clause pairs is not the key text segment, this candidate clause pair is filtered. It indicates that keywords of the two clauses in the candidate clause pair are different, and the candidate clause pair is filtered. The unsupervised identification algorithm may be a graph-based text processing and ranking algorithm, for example, one of three methods: a text rank algorithm, a term frequency-inverse document frequency (TF-IDF) method, or a rapid automatic keyword extraction (RAKE) algorithm, or the three methods may be combined to more accurately extract the keywords in the text.

In some embodiments, the filtering method may be a similarity matching method based on a text segment embedding (sentence embedding). Specifically, an editing distance between two clauses in the clause pair may be determined, or a longest common sub-sequence of two clauses may be determined, or the foregoing methods may also be used at the same time. When the editing distance is less than a distance threshold or the longest common sub-sequence is greater than a sequence number, it is determined that there is a similar clause. Considering that an effect of determining a similarity between text segment embeddings of a long sentence is poor, and a length standard of the long sentence is not easy to define, two clauses in the candidate clause pair may be further segmented to obtain a plurality of short sentences, and then whether there is a similar short sentence is determined. If there is a similar short sentence, a corresponding candidate clause pair is reserved, and if there is no similar short sentence, the candidate clause pair is filtered.

Operation 704: Determine a similarity between the candidate clause pairs.

Whether a clause of the candidate text may be a citation of a clause of the reply text is determined. Specifically, whether semantics of the clause of the candidate text in the candidate clause pair are similar to semantics of the reply text or whether the semantics of the clause of the candidate text include the semantics of the reply text is determined. If the semantics of the clause of the candidate text in the candidate clause pair are similar to the semantics of the reply text or the semantics of the clause of the candidate text include the semantics of the reply text, it may be determined that the candidate clause pair is the matched clause pair. Specifically, the matched clause pairs are determined from the plurality of candidate clause pairs, and a semantic similarity matching model may be used to calculate a semantic similarity between two clauses. When a calculated semantic similarity exceeds a similarity threshold, it indicates that the semantics of the clause of the reply text are similar to the semantics of the clause of the candidate text. In other words, the clause of the candidate text in the candidate clause pair may be used as the citation of the corresponding clause of the reply text, and it may be determined that the candidate clause pair is the matched clause pair. The similarity threshold may be set according to actual requirements, for example, may be 0.8.

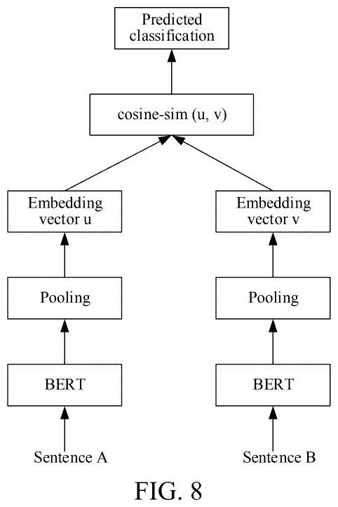

In some embodiments, the semantic similarity matching model (equivalent to the foregoing fourth language model) may be specifically a Sentence-BERT model. For a model prediction process, refer to FIG. 8. FIG. 8 is a prediction process diagram of a semantic similarity matching model according to an embodiment of this application. As shown in FIG. 8, a to-be-detected sentence A and a to-be-detected sentence B are first inputted into the model. After being encoded by a hidden layer of the BERT model, the two to-be-detected sentences are inputted into a pooling layer for pooling, to map the sentence A to an embedding vector u, and map the sentence B to an embedding vector v, where vector dimensions of u and v are the same. Then the embedding vector u and the embedding vector v are concatenated to obtain a fused vector output by the hidden layer, denoted as “|u-v|.” A specific concatenation method may be respectively adding elements in the embedding vector u to elements at corresponding positions in the embedding vector v. Then, the embedding vector u, the embedding vector v, and the fused vector are directly concatenated, and a feature obtained through concatenation is inputted into a fully-connected layer for prediction classification (Softmax classifier), to predict a semantic similarity between the sentence A and the sentence B. An activation function of the fully-connected layer is a Softmax function, and the semantic similarity may be a minimum editing distance similarity between the vectors, a euclidean distance similarity, or a cosine-similarity.

Operation 705: Perform matching based on a citation token in the reply text.

After it is determined that the clause of the candidate text in the matched clause pairs may be used as the citation text of the clause of the corresponding reply text, the clause of the candidate text may be inserted into an end of the clause of the corresponding reply text as the citation text by using the matched clause pairs based on the citation token of each clause in the reply text.

Operation 702 to operation 704, and operation 705 may be performed in parallel or in serial. This is not limited in this embodiment of this application.

Operation 706: Perform post-processing on the matched clause pairs.

After all the matched clause pairs satisfying the similarity threshold are determined in the candidate clause pair, the clause of the candidate text in the matched clause pairs may be used as the citation text of the corresponding clause of the reply text, and positions and quantities of sequence numbers of the citation text are adjusted based on the reply text.

Considering that the clauses of the candidate text and the clauses of the reply text are combined in pairs, the matched clause pairs are obtained. Therefore, in one clause of the reply text, there are a plurality of clauses of the candidate text as the citation text, that is, in one clause of the reply text, there are a plurality of citation texts. Sorting is performed based on the semantic similarity between the corresponding matched clause pairs, a clause of the candidate text having a highest semantic similarity with the clause of the reply text is directly added to the end of the clause of the reply text, and remaining citation texts (the clause of the candidate text) are sorted in sequence based on the semantic similarity, thereby completing post-processing of the matched clause pairs.

For example, in a clause A of the reply text, there are a plurality of clauses (for example, a clause B and a clause C) of the candidate text as the citation text, the semantic similarity between the clause A and the clause C is 0.9, and the semantic similarity between the clause A and the clause B is 0.8, so that the clause C is directly added to an end of the clause A as the citation text, and the clause B is also ranked behind the clause C as the citation text. In addition, the clause C of the candidate text may be adjusted to be a citation 1, and the clause B of the candidate text may be adjusted to be a citation 2, and then a quantity of citations of the clause A of the reply text is set to 2.

Operation 707: Generate a reply text having the citation text.

After the citation text is added to all the clauses of the reply text, after the large language model generates the reply text based on the query text, each clause in the reply text has the corresponding citation text, and the corresponding citation text content can be quickly found based on the sequence numbers of the citation texts.

According to this embodiment of this application, a text having a high similarity with a generated text (that is, the reply text) of the large language model is selected from the provided candidate text and used as the citation text, to add the citation content to each clause in the generated text, so that the authenticity and credibility of the text generated by the large language model is improved.

In conclusion, in this embodiment of this application, a plurality of latest text search results prioritizing timeliness that are generated by the query text invoking the search engine interface are first obtained, and then the related answer text segments matching the query text are extracted from the text search results, and selection is performed, to determine a text segment having a highest relevance with the query text from the plurality of answer text segments and determine the text segment as the reference text of the large language model. Then, the large language model is invoked to predict the reply text corresponding to the query text from the reference text, to generate the corresponding text, thereby improving the controllability of the content generated by the large language model and improving the timeliness of the generated content. Subsequently, the text having the high similarity with the generated text (that is, the reply text) of the large language model is selected out from the provided candidate text and used as the referenced text, to add the citation content to each clause in the generated text. Therefore, problems that it is difficult to determine the authenticity of the content and to further understand the content in depth since content generated by the large language model does not have the citation information can be resolved. In addition, the citation content is used as the citation material for the generated text of the large language model, to improve the authenticity and credibility of the generated text of the large language model and resolve the problems that low factuality, poor credibility, and fabrication exist in original generated text. In addition, the text processing method provided in this embodiment of this application is applied to a search system, and the reference material is rapidly selected from the search results through the query text, so that the efficiency of obtaining the search information can be significantly improved, and experience of the search system can be improved.

The following continues to describe an exemplary structure in which a text processing apparatus 453 according to an embodiment of this application is implemented as a software module. In some embodiments, as shown in FIG. 2, the software module in the text processing apparatus 453 stored in a memory 450 may include:

an obtaining module 4531, configured to: obtain a query text; invoke a search engine interface based on the query text, to obtain a plurality of text search results corresponding to the query text; and obtain a plurality of answer text segments matching the query text from the plurality of text search results; a determining module 4532, configured to determine a relevance between the query text and each of the plurality of answer text segments, and determine the answer text segment corresponding to a maximum relevance as a reference text of the query text; and an invoking module 4533, configured to invoke a first language model based on the query text and the reference text, to obtain a reply text of the query text.

In some embodiments, the obtaining module 4531 is further configured to: invoke the search engine interface based on the query text, so that the search engine interface searches for the plurality of text search results related to the query text in sorting a manner based on generation time; and obtain the plurality of text search results related to the query text from the search engine interface.

In some embodiments, the obtaining module 4531 is further configured to: segment the text search result into a plurality of candidate citation text segments of a fixed length; obtain a matching score between the query text and each of the plurality of candidate citation text segments, a start probability of each element in the candidate citation text segment being a start position of the answer text segment, and an end probability of each element in the candidate citation text segment being an end position of the answer text segment; determine an optimal matching segment, the optimal matching segment being the candidate citation text segment corresponding to a maximum matching score; determine a start element and an end element in the optimal matching segment, the start element being the element corresponding to a maximum start probability, and the end element being the element corresponding to a maximum end probability; and determine a part in the optimal matching segment that is located between the start element and the end element as an answer text segment matching the query text.

In some embodiments, the obtaining module 4531 is further configured to: combine each of the plurality of candidate citation text segments and the query text into a text pair; and invoke a second language model based on each text pair, to obtain the matching score between the query text and each of the plurality of candidate citation text segments, the start probability of each element in the candidate citation text segment being the start position of the answer text segment, and the end probability of each element in the candidate citation text segment being the end position of the answer text segment.

In some embodiments, the obtaining module 4531 is further configured to: use each element in the query text and the candidate citation text segment as one regular token, and concatenate the regular tokens into a first token sequence, a start token being inserted into a head of the first token sequence; perform embedding on the first token sequence, to obtain an embedding feature vector of the first token sequence; invoke the second language model to encode the embedding feature vector of the first token sequence, to obtain a semantic feature vector of the first token sequence; map a semantic feature vector of the start token in the semantic feature vector of the first token sequence, to obtain the matching score between the query text and the candidate citation text segment; and map a semantic feature vector corresponding to each regular token in the semantic feature vector of the first token sequence, to obtain the start probability of each element in the candidate citation text segment being the start position of the answer text segment and the end probability of each element in the candidate citation text segment being the end position of the answer text segment.

In some embodiments, the determining module 4532 is configured to: use each element in the query text, the answer text segment, and the title text as one regular token, and concatenate the regular tokens into a second token sequence, a start token being inserted into a head of the second token sequence, and the regular tokens between the query text and the answer text segment, and between the answer text segment and the title text being connected by a separator token; perform embedding on the second token sequence, to obtain an embedding feature vector of the second token sequence; invoke a third language model to encode the embedding feature vector of the second token sequence, to obtain a semantic feature vector of the second token sequence; and map the semantic feature vector of the second token sequence, to obtain the relevance between the query text and the answer text segment.

In some embodiments, the invoking module 4533 is configured to: invoke the first language model based on the query text and the reference text to perform prediction processing on the query text, to determine a start element and an end element of the reply text that are in the reference text; and use a text between the start element and the end element of the reference text as the reply text of the query text.

In some embodiments, the invoking module 4533 is further configured to: use each element in the query text and the reference text as one regular token, and concatenate the regular tokens into a third token sequence, a start token being inserted into a head of the third token sequence, and the regular tokens between the query text and the reference text being connected by a separator token;

perform embedding on the third token sequence, to obtain an embedding feature vector of the third token sequence; invoke the first language model to encode the embedding feature vector of the third token sequence, to obtain a semantic feature vector of each regular token in the third token sequence; map the semantic feature vector corresponding to each regular token, to obtain a start probability of each element of the reference text being the start element of the reply text and an end probability of each element of the reference text being the end element of the reply text; and determine the element corresponding to the maximum start probability as the start element of the reply text, and determine the element corresponding to the maximum end probability as the end element of the reply text.

In some embodiments, the determining module 4532 is further configured to: obtain a plurality of candidate citation texts, the candidate citation text including a material configured for citation in the reply text; segment the reply text into a plurality of answer text segments, and segment each candidate citation text into a plurality of citation text segments; and determine a citation text segment matching at least one answer text segment, and insert the citation text segment matching the at least one answer text segment into the reply text.

In some embodiments, the determining module 4532 is further configured to: combine the plurality of answer text segments and the plurality of citation text segments in pairs, to form a plurality of candidate text pairs; and identify at least one matching text pair from the plurality of candidate text pairs, and determine that the citation text segment in the matching text pair matches the answer text segment in the matching text pair.

In some embodiments, the determining module 4532 is further configured to: perform keyword identification on the answer text segment and the citation text segment in the candidate text pair respectively; and delete the candidate text pair in response to no keyword being identified from at least one of the answer text segment or the citation text segment.

In some embodiments, the determining module 4532 is further configured to: encode the answer text segment and the citation text segment in the candidate text pair respectively, to obtain an embedding feature vector of the answer text segment and an embedding feature vector of the citation text segment; determine a similarity between the embedding feature vector of the answer text segment and the embedding feature vector of the citation text segment; and delete the candidate text pair in response to the similarity being less than a similarity threshold.

In some embodiments, the determining module 4532 is further configured to: invoke a fourth language model to respectively encode the answer text segment and the candidate citation text segment in the candidate text pair, to obtain an embedding feature vector of the answer text segment and an embedding feature vector of the citation text segment; perform pooling processing on the embedding feature vector of the answer text segment and the embedding feature vector of the citation text segment respectively, to obtain a semantic feature vector of the answer text segment and a semantic feature vector of the citation text segment;

concatenate the semantic feature vector of the citation text segment and the semantic feature vector of the answer text segment, to obtain a fused feature vector of the candidate text pair; map the fused feature vector, to obtain a semantic similarity between the answer text segment and the citation text segment in the candidate text pair; and determine a candidate text pair whose semantic similarity is greater than a semantic similarity threshold as the matching text pair.

In some embodiments, the determining module 4532 is further configured to: insert, in response to a quantity of the at least one answer text segment being less than or equal to a first quantity threshold, the at least one citation text segment each matching one of the at least one answer text segment into a position after the corresponding answer text segment respectively; and insert, in response to a quantity of citation text segments matching the at least one answer text segment being greater than the first quantity threshold, the citation text segments respectively matching the at least one answer text segment into an end of the reply text uniformly.

In some embodiments, the determining module 4532 is further configured to: perform descending sorting based on a similarity between the at least one answer text segment and the citation text segment matching the at least one answer text segment in response to the quantity of citation text segments matching the at least one answer text segment being greater than a second quantity threshold, and use a set quantity or a set proportion of citation text segments matching the answer text segment as a to-be-inserted text segment starting from a head in a descending sorting result.

An embodiment of this application provides a computer program product. The computer program product includes a computer program or computer-executable instructions, and the computer program or the computer-executable instructions are stored in a computer- readable storage medium. A processor of an electronic device reads the computer-executable instructions from the computer-readable storage medium, and the processor executes the computer-executable instructions, so that the electronic device executes the foregoing text processing method in the embodiments of this application.

An embodiment of this application provides a computer-readable storage medium, having computer-executable instructions or a computer program stored therein. When the computer-executable instructions or the computer program is executed by a processor, the processor is caused to perform the text processing method according to the embodiments of this application, for example, the text processing method shown in FIG. 3A to FIG. 3L.

In some embodiments, the computer-readable storage medium may be a memory such as a RAM, a ROM, a flash memory, a magnetic surface memory, an optical disc, or a CD-ROM, or may be various devices including one or any combination of the memories.

In some embodiments, the computer-executable instructions may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit applicable for use in a computing environment.

For example, the computer-executable instructions may, but do not necessarily correspond to a file in a file system, and may be stored as a part of a file that saves another program or data, for example, stored in one or more scripts in a hyper text markup language (HTML) file, stored in a single file dedicated to a program in discussion, or stored in a plurality of collaborative files (for example, files that store one or more modules, subprograms, or code parts).

For example, the computer-executable instructions may be deployed to be executed on one electronic device, or executed on a plurality of electronic devices located at one position, or executed on a plurality of electronic devices that are distributed in a plurality of positions and interconnected by a communication network.

In conclusion, according to this embodiment of this application, a plurality of text search results with timeliness generated by the query text invoking the search engine interface are obtained; and then the related answer text segments matching the query text are extracted from the text search results, and selection is performed on the answer text segments, to determine a text segment having a highest relevance with the query text from the plurality of answer text segments and determine the text segment as the reference text of the large language model. Then, the large language model is invoked to predict the reply text corresponding to the query text from the reference text, to generate the corresponding text, thereby improving controllability of the content generated by the large language model and improving the timeliness of the generated content. Text having a high similarity with the generated text (that is, the reply text) of the large language model is selected out from the provided candidate citation text and used as the citation text, to add the citation content to each clause in the generated text. Therefore, problems that it is difficult to determine authenticity of the content and to further understand the content in depth since content generated by the large language model does not have the citation information can be solved. In addition, the citation content is used as the citation material for the generated text of the large language model, to improve authenticity and credibility of the generated text of the large language model and resolve problems that low factuality, poor credibility, and fabrication exist in original generated text. In addition, the text processing method provided in this embodiment of this application is applied to the search system, and the reference material is rapidly selected from the search results through the query text, so that efficiency of obtaining the search information can be significantly improved, and experience of the search system can be improved.

The foregoing descriptions described above are merely examples of the embodiments of this application, and this is not intended to limit the protection scope of this application. Any modification, equivalent replacement, and improvement made within the spirit and scope of this application shall fall within the scope of this application.

What is claimed is:

1. A text processing method, performed by an electronic device, comprising:
obtaining a query text;
invoking a search engine interface based on the query text, to obtain a plurality of text search results corresponding to the query text;
obtaining, from the plurality of text search results, a plurality of answer text segments matching the query text;
determining a relevance between the query text and each of the plurality of answer text segments, and determining one of the plurality of answer text segments that corresponds to a maximum relevance as a reference text of the query text; and
invoking a language model based on the query text and the reference text, to obtain a reply text of the query text.

2. The method according to claim 1, wherein invoking the search engine interface based on the query text, to obtain the plurality of text search results includes:
invoking the search engine interface based on the query text, to cause the search engine interface searches for the plurality of text search results related to the query text in a sorting manner based on generation time; and
obtaining the plurality of text search results related to the query text from the search engine interface.

3. The method according to claim 1, wherein obtaining the plurality of answer text segments includes, for each text search result:
segmenting the text search result into a plurality of candidate citation text segments of a fixed length;
for each of the plurality of candidate citation text segments, obtaining a matching score between the query text and the candidate citation text segment, a start position probability of each element in the candidate citation text segment being a start position of one answer text segment of the plurality of answer text segments, and an end position probability of each element in the candidate citation text segment as an end position of the one answer text segment;
determining an optimal matching segment, the optimal matching segment being the candidate citation text segment corresponding to a maximum matching score;
determining a start element and an end element in the optimal matching segment, the start element being an element corresponding to a maximum start position probability, and the end element being an element corresponding to a maximum end position probability; and
determining a part in the optimal matching segment that is located between the start element and the end element as the one answer text segment.

4. The method according to claim 3, wherein:
the language model is a first language model; and
obtaining the matching score between the query text and the candidate citation text segment, and the start position probability and the end position probability of each element in the candidate citation text segment includes:
combining the candidate citation text segment and the query text into a text pair; and
invoking a second language model based on the text pair, to obtain the matching score between the query text and the candidate citation text segment, and the start position probability and the end position probability of each element in the candidate citation text segment.

5. The method according to claim 4, wherein invoking the second language model to obtain the matching score between the query text and the candidate citation text segment, and the start position probability and the end position probability of each element in the candidate citation text segment includes:
concatenating elements in the query text and the candidate citation text segment into a token sequence with each element in the query text and the candidate citation text segment being one regular token in the token sequence, the token sequence further including a start token in a head of the token sequence;
performing embedding on the token sequence, to obtain an embedding feature vector of the token sequence;
invoking the second language model to encode the embedding feature vector of the token sequence, to obtain a semantic feature vector of the token sequence;
mapping a semantic feature vector of the start token in the semantic feature vector of the token sequence, to obtain the matching score between the query text and the candidate citation text segment; and
mapping a semantic feature vector corresponding to each regular token in the semantic feature vector of the token sequence, to obtain the start position probability and the end position probability of each element in the candidate citation text segment.

6. The method according to claim 1, wherein:
each of the plurality of answer text segments includes a title text;
the language model is a first language model; and
determining the relevance between the query text and each of the plurality of answer text segments includes, for each answer text segment:
concatenating elements in the query text, the answer text segment, and the title text into a token sequence with each element in the query text, the answer text segment, and the title text being one regular token in the token sequence, the token sequence further including a start token in a head of the token sequence, and one or more separator token each connecting the regular tokens between the query text and the answer text segment, and between the answer text segment and the title text;
performing embedding on the token sequence, to obtain an embedding feature vector of the token sequence;
invoking a second language model to encode the embedding feature vector of the token sequence, to obtain a semantic feature vector of the token sequence; and
mapping the semantic feature vector of the token sequence, to obtain the relevance between the query text and the answer text segment.

7. The method according to claim 1, wherein invoking the language model to obtain the reply text includes:
invoking the language model based on the query text and the reference text to perform prediction processing on the query text, to determine a start element and an end element of the reply text that are in the reference text; and
determining a text between the start element and the end element of the reference text as the reply text of the query text.

8. The method according to claim 7, wherein invoking the language model to perform prediction processing on the query text and the reference text includes:
concatenating elements in the query text and the reference text into a token sequence with each element in the query text and the reference text being one regular token in the token sequence, the token sequence further including a start token in a head of the token sequence and one or more separator tokens each connecting the regular tokens between the query text and the reference text;
performing embedding on the token sequence, to obtain an embedding feature vector of the token sequence;
invoking the language model to encode the embedding feature vector of the token sequence, to obtain a semantic feature vector of each regular token in the token sequence;
mapping the semantic feature vector corresponding to each regular token, to obtain a start probability of each element of the reference text being the start element of the reply text and an end probability of each element of the reference text being the end element of the reply text; and
determining the element corresponding to a maximum start probability as the start element of the reply text, and determining the element corresponding to a maximum end probability as the end element of the reply text.

9. The method according to claim 1, further comprising, after invoking the language model to obtain the reply text:
obtaining a candidate citation text including a material configured for being cited in the reply text;
segmenting the reply text into a plurality of answer text segments, and segmenting the candidate citation text into a plurality of citation text segments; and
determining at least one matching citation text segment each matching one of at least one answer text segment, and inserting the at least one matching citation text segment into the reply text.

10. The method according to claim 9, wherein determining the at least one matching citation text segment includes:
combining the plurality of answer text segments and the plurality of citation text segments in pairs, to form a plurality of candidate text pairs; and
identifying at least one matching text pair from the plurality of candidate text pairs, the citation text segment and the answer text segment in each of the at least one matching text pair matching each other.

11. The method according to claim 10, wherein:
the language model is a first language model; and
identifying the at least one matching text pair includes, for one candidate text pair of the plurality of candidate text pairs:
invoking a second language model to encode the answer text segment and the candidate citation text segment in the one candidate text pair, to obtain an embedding feature vector of the answer text segment and an embedding feature vector of the citation text segment;
performing pooling processing on the embedding feature vector of the answer text segment and the embedding feature vector of the citation text segment, to obtain a semantic feature vector of the answer text segment and a semantic feature vector of the citation text segment;
concatenating the semantic feature vector of the citation text segment and the semantic feature vector of the answer text segment, to obtain a fused feature vector of the one candidate text pair;
mapping the fused feature vector, to obtain a semantic similarity between the answer text segment and the citation text segment in the one candidate text pair; and
determining, in response to the semantic similarity of the one candidate text pair being greater than a semantic similarity threshold, the one candidate text pair as one of the at least one matching text pair.

12. The method according to claim 10, further comprising, before identifying the at least one matching text pair, for each candidate text pair:
performing keyword identification on the answer text segment and the citation text segment in the candidate text pair; and
deleting the candidate text pair in response to failing to identify keyword in at least one of the answer text segment or the citation text segment.

13. The method according to claim 10, further comprising, before identifying the at least one matching text pair, for each candidate text pair:
encoding the answer text segment and the citation text segment in the candidate text pair, to obtain an embedding feature vector of the answer text segment and an embedding feature vector of the citation text segment;
determining a similarity between the embedding feature vector of the answer text segment and the embedding feature vector of the citation text segment; and
deleting the candidate text pair in response to the similarity being less than a similarity threshold.

14. The method according to claim 9, wherein inserting the at least one matching citation text segment into the reply text includes:
inserting, in response to a quantity of the at least one answer text segment being less than or equal to a quantity threshold, each of the at least one matching citation text segment at a position after a corresponding one of the at least one answer text segment; and
inserting, in response to a quantity of the at least one answer text segment being greater than the quantity threshold, the at least one matching citation text segment to an end of the reply text.

15. The method according to claim 9, further comprising, before inserting the at least one matching citation text segment into the reply text:
in response to a quantity of the at least one matching citation text segment being greater than a quantity threshold, performing descending sorting based on a similarity between each of the at least one matching citation text segment and a corresponding one of the at least one answer text segment, and determining each of a set quantity or a set proportion of the at least one matching citation text segment starting from a head of the sorted at least one matching citation text segment in a descending sorting result as a candidate text segment for insertion into the reply.

16. An electronic device comprising:
a memory storing computer-executable instructions or a computer program; and
a processor configured to execute the computer-executable instructions or the computer program to:
obtain a query text;
invoke a search engine interface based on the query text, to obtain a plurality of text search results corresponding to the query text;
obtain, from the plurality of text search results, a plurality of answer text segments matching the query text;
determine a relevance between the query text and each of the plurality of answer text segments, and determine one of the plurality of answer text segments that corresponds to a maximum relevance as a reference text of the query text; and
invoke a language model based on the query text and the reference text, to obtain a reply text of the query text.

17. The electronic device according to claim 16, wherein the processor is further configured to execute the computer-executable instructions or the computer program to, when invoking the search engine interface based on the query text, to obtain the plurality of text search results:
invoke the search engine interface based on the query text, to cause the search engine interface searches for the plurality of text search results related to the query text in a sorting manner based on generation time; and
obtain the plurality of text search results related to the query text from the search engine interface.

18. The electronic device according to claim 16, wherein the processor is further configured to execute the computer-executable instructions or the computer program to, when obtaining the plurality of answer text segments, for each text search result:
segment the text search result into a plurality of candidate citation text segments of a fixed length;
for each of the plurality of candidate citation text segments, obtain a matching score between the query text and the candidate citation text segment, a start position probability of each element in the candidate citation text segment being a start position of one answer text segment of the plurality of answer text segments, and an end position probability of each element in the candidate citation text segment as an end position of the one answer text segment;
determine an optimal matching segment, the optimal matching segment being the candidate citation text segment corresponding to a maximum matching score;
determine a start element and an end element in the optimal matching segment, the start element being an element corresponding to a maximum start position probability, and the end element being an element corresponding to a maximum end position probability; and
determine a part in the optimal matching segment that is located between the start element and the end element as the one answer text segment.

19. The electronic device according to claim 18, wherein:
the language model is a first language model; and
the processor is further configured to execute the computer-executable instructions or the computer program to, when obtaining the matching score between the query text and the candidate citation text segment, and the start position probability and the end position probability of each element in the candidate citation text segment:
combine the candidate citation text segment and the query text into a text pair; and
invoke a second language model based on the text pair, to obtain the matching score between the query text and the candidate citation text segment, and the start position probability and the end position probability of each element in the candidate citation text segment.

20. A non-transitory computer-readable storage medium storing computer-executable instructions or a computer program that, when executed by a processor, causes an electronic device having the processor to:
obtain a query text;
invoke a search engine interface based on the query text, to obtain a plurality of text search results corresponding to the query text;
obtain, from the plurality of text search results, a plurality of answer text segments matching the query text;
determine a relevance between the query text and cach of the plurality of answer text segments, and determine one of the plurality of answer text segments that corresponds to a maximum relevance as a reference text of the query text; and
invoke a language model based on the query text and the reference text, to obtain a reply text of the query text.
